(19) United States
(12) Patent Application Publication
(10) Pub. No.: US 2014/0213445 A1
(43) Pub. Date: Jul. 31, 2014

(54) Use of Pesticidal Active 3-Arylquinazolin-4-One Derivatives in Soil Application Methods

(71) Applicants: Florian Kaiser, Mannheim (DE); Steffen Gross, Ludwigshafen (DE); Arun Narine, Mannheim (DE); Koshi Gunjima, Cary, NC (US)

(72) Inventors: Florian Kaiser, Mannheim (DE); Steffen Gross, Ludwigshafen (DE); Arun Narine, Mannheim (DE); Koshi Gunjima, Cary, NC (US)

(73) Assignee: BASF SE, Ludwigshafen (DE)

(21) Appl. No.: 14/241,262

(22) PCT Filed: Aug. 31, 2012
(86) PCT No.: PCT/EP2012/066933

§ 371 Date: Feb. 26, 2014

Related U.S. Application Data
(60) Provisional application No. 61/530,455, filed on Sep. 2, 2011.

(51) Int. Cl. A01N 43/54

(52) U.S. Cl. CPC A01N 43/54
USPC 504/100; 514/266.3; 544/290

(57) ABSTRACT

The present invention relates to agricultural methods and the use of 3-arylquinazolin-4-one derivatives of formula (I)

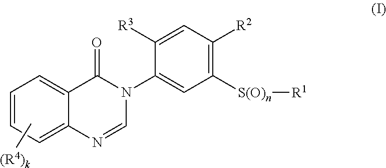

wherein R¹, R², R³, R⁴, k and n are defined in the description in soil application methods.

The compounds of the formula (I) are highly suitable for controlling animal pests such as insects and/or spider mites and/or nematodes by treating the soil/growth substrate by drenching or drip application or dipping or soil injection.

The present invention relates to the use of 3-arylquinazolin-4-one derivatives for controlling arthropods, especially insects and arachnids, more especially (spider) mites, and/or nematodes by soil application methods such as drenching, drip application, dip application or soil injection or by seed treatment.

Invertebrate pests, arthropods and nematodes, and in particular insects and arachnids, destroy growing and harvested crops and attack wooden dwelling and commercial structures, thereby causing large economic loss to the food supply and to property. While a large number of pesticidal agents are known, due to the ability of target pests to develop resistance to said agents, there is an ongoing need for new agents for combating invertebrate pests such as insects, arachnids and nematodes.

Especially soil-living pests, arthropod pests, including soil-living insects and arachnids, and especially spider mites, and nematodes, are often controlled and combated by applying an effective amount of a suitable pesticide compound to the soil, e.g. by drenching, drip application, dip application or soil injection. The pesticidal compounds may further be applied as a solid or liquid composition, e.g. such as a dust or granule formulation comprising an inert carrier, e.g. such as clay.

Methods of soil application can suffer from several problems. Pesticidal compounds are not always especially suitable for being applied by different soil application methods such as by drenching, drip application, dip application or soil injection. Their pesticidal activity may be affected in some cases.

It is therefore an object of the present invention to provide compounds having a good pesticidal activity and a good applicability in techniques of soil treatment against a large number of different invertebrate pests, especially against soil-living pests, which are difficult to control.

Some soil-applied pesticides compositions may also have potential for leaching. Therefore, care must be taken to minimize both surface and ground water contamination. Moreover, the effectiveness of the pesticide may vary depending on environmental conditions—e.g. properly timed rain is needed for the successful functioning of the chemistry in the soil, but too much rain may reduce the effectiveness and may cause leaching.

It is therefore also an object of the present invention to provide compositions which are suitable for combating soil-living pests and which overcome the problems associated with the known techniques. In particular the compositions should be applicable easily and provide a long-lasting action on soil-living pests. Moreover, environmental conditions should not have an adverse effect on the effectiveness of the pesticide.

Soil application methods are considered as different techniques of applying pesticidal compounds directly or indirectly to the soil and/or ground, such as drip applications or drip irrigations (onto the soil), or soil injection, further methods of drenching the soil. Furthermore, object of the present inventions are methods of application by dipping roots, tubers or bulbs (referred to as dip application), by hydroponic systems or also by seed treatment.

Another of the problems the farmer is faced with in this context is, that seeds and plant roots and shoots are constantly threatened by foliar and soil insects and other pests.

Thus a further difficulty in relation to the use of such seed protection pesticides is that the repeated and exclusive application of an individual pesticidal compound leads also here in many cases to a rapid selection of soil pests, which have developed natural or adapted resistance against the active compound in question. Therefore there is a need for seed protection agents that help prevent or overcome resistance.

It is therefore a further object of the present invention to provide compounds which solve the problems of protection of the protection of seeds and growing plants, reducing the dosage rate, enhancing the spectrum of activity and/or to manage pest resistance.

The present invention therefore also provides methods for the protection of to plant proparagation material, especially seeds, from soil insects and of the resulting plant's roots and shoots from soil and foliar insects.

The invention also relates to plant proparagation material, especially seeds, which is protected from soil and foliar insects.

It is therefore especially an object of the present invention to provide methods of application, which are suitable for combating soil-living pests

Surprisingly, it has now been found that 3-arylquinazolin-4-one compounds of formula (I) of the present invention

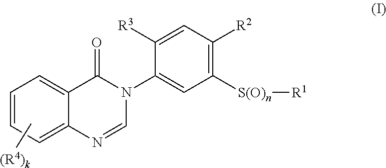

wherein
R¹ is C₁-C₄-alkyl, fluorinated C₁-C₄-alkyl, C₂-C₄-alkenyl, fluorinated C₂-C₄-alkenyl, cyclopropyl or cyclopropylmethyl;
R² is hydrogen, halogen, CN, C₁-C₄-alkyl or C₁-C₄-haloalkyl;
R³ is hydrogen, halogen, CN, C₁-C₄-alkyl or C₁-C₄-haloalkyl;
R⁴ is selected independently from the integer of k from the group consisting of halogen, CN, NO₂, C₁-C₄-alkyl, C₁-C₄-haloalkyl, C₂-C₄-alkenyl, C₁-C₄-haloalkenyl, C₂-C₄-alkynyl, C₁-C₄-haloalkynyl, C₁-C₄-alkoxy-C₁-C₄-alkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl and C₁-C₄-haloalkylsulfonyl;
k is 0, 1, 2, 3 or 4;
n is 0, 1 or 2;
or the tautomers, enantiomers, diastereomers or salts thereof,

are highly suitable for methods for controlling and/or combating insects, acarids and/or nematodes, and especially spider mites, by soil application and seed treatment methods.

3-arylquinazolin-4-one derivatives showing generally pesticidal activity have been described previously. DE 19547475 describes 3-(2,4-dioxo-pyrimidin-3-yl)-6-cyano-phenyl sulfide derivatives and their applications for protecting crops against harmful insects and weeds. U.S. Pat. No. 6,509,354 describes 3-(4-oxo-pyrimidin-3-yl)-phenyl sulfide derivatives and their activities against various insect and mite pests. U.S. Pat. No. 3,755,581 A describes aryl quinazolones and their applications for protecting crops against phytopathogenic bacteria and funghi, insects and gastropods. EP 1076053 A1 describes aryl phenyl sulphide derivatives and their applications for protecting crops against insects and mites. WO 2011/006605 A1 describes use of phenyl triazoles for controlling insects and spidermites by spashing, misting or immersion or by treatment of seeds. Pesticidal active arylquinazolinone compounds have been described in WO/2010/100189.

However, their surprisingly excellent applicability for soil application techniques as well as seed treatment, and their extraordinary activity against soil-living pests have not been described previously.

Compounds

The terms “compound(s) for methods according to the (present) invention”, “compound(s) according to the (present) invention” or “compound(s) of formula (I)”, which compound(s) are applied in methods according to the present invention comprise the compound(s) as defined herein as well as a stereoisomer, salt, tautomer or N-oxide thereof.

The term “composition(s) according to the invention” or “composition(s) of the present invention” encompasses composition(s) comprising at least one compound of formula (I) for being used and/or applied in methods according to the invention as defined above.

The compounds of the present invention, i.e. the compounds of formula (I), their stereoisomers, their salts or their N-oxides, are particularly useful for being applied in methods for soil application methods for controlling invertebrate pests, in particular for controlling insects, arthropods and nematodes and especially (spider) mites. Therefore, the invention relates to the use of a compound of the present invention, for combating or controlling invertebrate pests, in particular invertebrate pests of the group of insects, arachnids or nematodes.

The compounds of the present invention can be applied in accordance with the invention on their own, but also in combination with other insecticidal and/or acaricidal active substances.

The present invention relates further to a composition comprising at least one compound according to the invention, including a stereoisomer, salt, tautomer or N-oxide thereof, and at least one inert liquid and/or solid carrier. In particular, the invention relates to an agricultural composition comprising at least one compound according to the invention including a stereoisomer, an agriculturally acceptable salt, tautomer or an N-oxide thereof, and at least one liquid and/or solid carrier.

Depending on the substitution pattern, the compounds of the formula (I) may have one or more centers of chirality, in which case they are present as mixtures of enantiomers or diastereomers. The invention provides both the single pure enantiomers or pure diastereomers of the compounds of formula (I), and their mixtures and the use according to the invention of the pure enantiomers or pure diastereomers of the compound of formula (I) or its mixtures. Suitable compounds of the formula (I) also include all possible geometrical stereoisomers (cis/trans isomers) and mixtures thereof. Cis/trans isomers may be present with respect to an alkene, carbon-nitrogen double-bond or amide group. The term “stereoisomer(s)” encompasses both optical isomers, such as enantiomers or diastereomers, the latter existing due to more than one center of chirality in the molecule, as well as geometrical isomers (cis/trans isomers). The present invention relates to every possible stereoisomer of the compounds of formula I, i.e. to single enantiomers or diastereomers, as well as to mixtures thereof.

Depending on the substitution pattern, the compounds of the formulae (I) may be present in the form of their tautomers. Hence the invention also relates to the tautomers of the formula (I) and the stereoisomers, salts, tautomers and N-oxides of said tautomers. The compounds of the present invention may be amorphous or may exist in one ore more different crystalline states (polymorphs) or modifications which may have a different macroscopic properties such as stability or show different biological properties such as activities. The present invention includes both amorphous and crystalline compounds of the formula I, mixtures of different crystalline states or modifications of the respective compound I, as well as amorphous or crystalline salts thereof.

Salts of the compounds of the formula I are preferably agriculturally acceptable salts. They can be formed in a customary method, e.g. by reacting the compound with an acid of the anion in question if the compound of formula I has a basic functionality or by reacting an acidic compound of formula I with a suitable base.

Suitable agriculturally useful salts are especially the salts of those cations or the acid addition salts of those acids whose cations and anions, respectively, do not have any adverse effect on the action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethylammonium, bis(2-hydroxyethyl)ammonium, benzyltrimethylammonium and benzyltriethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formate, acetate, propionate and butyrate. They can be formed by reacting the compounds of the formulae I with an acid of the corresponding anion, preferably of hydrochloric acid, hydrobromic acid, sulfuric acid, phosphoric acid or nitric acid.

The term “N-oxide” includes any compound of the present invention which has at least one tertiary nitrogen atom that is oxidized to an N-oxide moiety.

The organic moieties mentioned in the above definitions of the variables are—like the term halogen—collective terms for individual listings of the individual group members. The prefix Cₙ-Cₘ indicates in each case the possible number of carbon atoms in the group.

“Halogen” will be taken to mean fluoro, chloro, bromo and iodo.

The term “partially or fully halogenated” will be taken to mean that 1 or more, e.g. 1, 2, 3, 4 or 5 or all of the hydrogen atoms of a given radical have been replaced by a halogen atom, in particular by fluorine or chlorine.

The term “Cₙ-Cₘ-alkyl” as used herein (and also in Cₙ-Cₘ-alkylamino, di-Cₙ-Cₘ-alkylamino, Cₙ-Cₘ-alkylaminocarbonyl, di-(Cₙ-Cₘ-alkylamino)carbonyl, Cₙ-Cₘ-alkylthio, Cₙ-Cₘ-alkylsulfinyl and Cₙ-Cₘ-alkylsulfonyl) refers to a branched or unbranched saturated hydrocarbon group having n to m, e.g. 1 to 10 carbon atoms, preferably 1 to 6 carbon atoms, for example methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl, 2-ethylhexyl, nonyl and decyl and their isomers. C₁-C₄-alkyl means for example methyl, ethyl, propyl, 1-methylethyl, butyl, 1-methylpropyl, 2-methylpropyl or 1,1-dimethylethyl.

The term “Cₙ-Cₘ-haloalkyl” as used herein (and also in Cₙ-Cₘ-haloalkylsulfinyl and Cₙ-Cₘ-haloalkylsulfonyl) refers to a straight-chain or branched alkyl group having n to m carbon atoms, e.g. 1 to 10 in particular 1 to 6 carbon atoms (as mentioned above), where some or all of the hydrogen atoms in these groups may be replaced by halogen atoms as mentioned above, for example C₁-C₄-haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl and the like. The term C₁-C₁₀-haloalkyl in particular comprises C₁-C₂-fluoroalkyl, which is synonym with methyl or ethyl, wherein 1, 2, 3, 4 or 5 hydrogen atoms are substituted by fluorine atoms, such as fluoromethyl, difluoromethyl, trifluoromethyl, 1-fluoroethyl, 2-fluoroethyl, 2,2-difluoroethyl, 2,2,2-trifluoroethyl and pentafluoromethyl.

Similarly, “Cₙ-Cₘ-alkoxy” and “Cₙ-Cₘ-alkylthio” (or Cₙ-Cₘ-alkylsulfenyl, respectively) refer to straight-chain or branched alkyl groups having n to m carbon atoms, e.g. 1 to 10, in particular 1 to 6 or 1 to 4 carbon atoms (as mentioned above) bonded through oxygen or sulfur linkages, respectively, at any bond in the alkyl group. Examples include C₁-C₄-alkoxy such as methoxy, ethoxy, propoxy, isopropoxy, butoxy, sec-butoxy, isobutoxy and tert-butoxy, further C₁-C₄-alkylthio such as methylthio, ethylthio, propylthio, isopropylthio, and n-butylthio.

Accordingly, the terms “Cₙ-Cₘ-haloalkoxy” and “Cₙ-Cₘ-haloalkylthio” (or Cₙ-Cₘ-haloalkylsulfenyl, respectively) refer to straight-chain or branched alkyl groups having n to m carbon atoms, e.g. 1 to 10, in particular 1 to 6 or 1 to 4 carbon atoms (as mentioned above) bonded through oxygen or sulfur linkages, respectively, at any bond in the alkyl group, where some or all of the hydrogen atoms in these groups may be replaced by halogen atoms as mentioned above, for example C₁-C₂-haloalkoxy, such as chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy and pentafluoroethoxy, further C₁-C₂-haloalkylthio, such as chloromethylthio, bromomethylthio, dichloro-methylthio, trichloromethylthio, fluoromethylthio, difluoromethylthio, trifluoromethylthio, chlorofluoromethylthio, dichlorofluoromethylthio, chlorodifluoromethylthio, 1-chloroethylthio, 1-bromoethylthio, 1-fluoroethylthio, 2-fluoroethylthio, 2,2-difluoroethylthio, 2,2,2-trifluoroethylthio, 2-chloro-2-fluoroethylthio, 2-chloro-2,2-difluoroethylthio, 2,2-dichloro-2-fluoroethylthio, 2,2,2-trichloroethylthio and pentafluoroethylthio and the like. Similarly the terms C₁-C₂-fluoroalkoxy and C₁-C₂-fluoroalkylthio refer to C₁-C₂-fluoroalkyl which is bound to the remainder of the molecule via an oxygen atom or a sulfur atom, respectively.

The term “C₂-Cₘ-alkenyl” as used herein intends a branched or unbranched unsaturated hydrocarbon group having 2 to m, e.g. 2 to 10 or 2 to 6 carbon atoms and a double bond in any position, such as ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl.

The term “C₂-Cₘ-alkynyl” as used herein refers to a branched or unbranched unsaturated hydrocarbon group having 2 to m, e.g. 2 to 10 or 2 to 6 carbon atoms and containing at least one triple bond, such as ethynyl, propynyl, 1-butynyl, 2-butynyl, and the like.

Formulations

The invention also relates to agrochemical compositions suitable for applying in soil treatment methods comprising an auxiliary and at least one compound of formula (I) according to the invention.

An agrochemical composition comprises a pesticidally effective amount of a compound of formula (I). The term “effective amount” denotes an amount of the composition or of the compounds I, which is sufficient for controlling harmful pests on cultivated plants or in the protection of materials and which does not result in a substantial damage to the treated plants. Such an amount can vary in a broad range and is dependent on various factors, such as the animal pests species to be controlled, the treated cultivated plant or material, the climatic conditions and the specific compound I used.

The compounds of formula (I), their N-oxides and salts can be converted into customary types of agrochemical compositions, e.g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Inform a, London, 2005.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e.g. toluene, paraffin, tetrahydronaphthalene, alkylated naphthalenes; alcohols, e.g. ethanol, propanol, butanol, benzylalcohol, cyclo [symbol] hexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl naphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof.

Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkyl-polyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or poly-ethyleneamines.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

The agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying compound I and compositions thereof, respectively, on to plant propagation material, especially seeds include dressing, coating, pelleting, dusting, soaking and infurrow application methods of the propagation material. Preferably, compound I or the compositions thereof, respectively, are applied on to the plant propagation material by a method such that germination is not induced, e.g. by seed dressing, pelleting, coating and dusting.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

In treatment of plant propagation materials such as seeds, e.g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seeds) are generally required. When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and further pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate. In a further embodiment, either individual components of the composition according to the invention or partially premixed components, e.g. components comprising compounds I and/or active substances from the groups M.1 to M.24 or F.I) to F.XII), may be mixed by the user in a spray tank and further auxiliaries and additives may be added, if appropriate.

In a further embodiment, either individual components of the composition according to the invention or partially premixed components, e.g. components comprising compounds I and/or active substances from the groups M.1 to M.24 or F.I) to F.XII), can be applied jointly (e.g. after tank mix) or consecutively.

Applications

The present invention relates to the methods by use on natural substrates (soil) or artificial (growth) substrates (e.g. rock wool, glass wool, quartz sand, gravel, expanded clay, vermiculite), in the open or in closed systems (e.g. greenhouses or under film mulch) and in annual crops (such as vegetables, spices, ornamentals) or perennial crops (such as citrus plants, fruits, tropical crops, spices, nuts, grapevines, conifers and ornamentals).

It has now been found that the problems associated with combating soil-living pests by pesticide treatment of the soil can be overcome by such application methods using compounds of the present invention.

The animal pest, i.e. the insects, arachnids and nematodes, the plant, the water or the soil in which the plant is growing can be contacted with the present compounds of formula I or composition(s) containing them by any application method known in the art. As such, “contacting” includes both direct contact (applying the compounds/compositions directly on the animal pest or plant) and indirect contact (applying the compounds/compositions to the locus of the animal pest or plant). When the plant is contacted, typically the tuber, bulbs or roots of the plant are contacted. The compounds of formula (I) may further be applied to other parts of the plant, such as leaves in case of foliar application, or to plant propagation material such as seeds in the case of seed treatment.

The compounds of formula I or the pesticidal compositions comprising them may be used to protect growing plants and crops from attack or infestation by animal pests, especially insects, acaridae or arachnids by contacting the plant/crop with a pesticidally effective amount of compounds of formula I. The term “crop” refers both to growing and harvested crops.

Thus, as with regards to the use and for the purpose of the present invention, vegetables are to be understood as meaning for example fruiting vegetables and inflorescences as vegetables, i.e. bell peppers, chillies, tomatoes, aubergines, cucumbers, pumpkins, courgettes, broad beans, climbing and dwarf beans, peas, artichokes and maize. Further also leafy vegetables like head-forming lettuce, chicory, endives, various types of cress, of rocket, lamb's lettuce, iceberg lettuce, leeks, spinach and chard. Furthermore tuber vegetables, root vegetables and stem vegetables, like celeriac/celery, beetroot, carrots, radish, horseradish, scorzonera, asparagus, beet for human consumption, palm hearts and bamboo shoots. Further also bulb vegetables like onions, leeks, fennel and garlic. Brassica vegetables such as cauliflower, broccoli, kohlrabi, red cabbage, white cabbage, curly kale, Savoy cabbage, Brussels sprouts and Chinese cabbage are also vegetable in the sense of the present application.

Regarding the use and for the purpose of the present invention, perennial crops are to be understood as meaning citrus, for example, oranges, grapefruits, tangerines, lemons, limes, Seville oranges, cumquats and satsumas. Also pome fruit such as, for example, apples, pears and quinces, and stone fruit such as, for example, peaches, nectarines, cherries, plums, quetsch, apricots. Further grapevines, hops, olives, tea and tropical crops such as, for example, mangoes, papayas, figs, pineapples, dates, bananas, durians, kaki fruit, coconuts, cacao, coffee, avocados lychees, maracujas, and. guavas. Furthermore soft fruit such as, for example, currants, gooseberries, raspberries, blackberries, blueberries, strawberries, cranberries, kiwi fruit and American cranberries. Almonds and nuts such as, for example, hazelnuts, walnuts, pistachios, cashew nuts, para nuts, pecan nuts, butternuts, chestnuts, hickory nuts, macadamia nuts and peanuts are also fruits in the sense of the present invention.

As with regard to the use and for the purpose of the present invention, ornamentals are understood as meaning annual and perennial plants, for example cut flowers such as, for example, roses, carnations, gerbera, lilies, marguerites, chrysanthemums, tulips, narcissus, anemones, poppies, amaryllis, dahlias, azaleas, hibiscus, but also for example border plants, pot plants and perennials such as, for example, roses, Tagetes, violas, geraniums, fuchsias, hibiscus, chrysanthemum, busy lizzie, cyclamen, African violet, sunflowers, begonias.

Furthermore for example also bushes and conifers such as, for example, ficus, rhododendron, firs, spruces, pines, yews, juniper, umbrella pines, oleander.

As regards the use, spices are understood as meaning annual and perennial plants such as, for example, aniseed, chilli pepper, paprika, pepper, vanilla, marjoram, thyme, cloves, juniper berries, cinnamon, tarragon, coriander, saffron, ginger.

Furthermore the compounds of the present invention and the compositions comprising them are particularly important in the control of a multitude of insects on various cultivated plants, such as cereal and oil crops, for example seed of durum and other wheat, barley, oats, rye, maize (fodder maize and sugar maize/sweet and field corn), soybeans, oil crops, crucifers, cotton, bananas, rice, oilseed rape, turnip rape, sugarbeet, fodder beet, eggplants, potatoes, grass, lawn, turf, fodder grass, sugar cane or tobacco.

The compounds of the invention can also be applied preventively to places at which occurrence of the pests is expected.

“Locus” means a habitat, breeding ground, plant, seed, soil, area, material or environment in which a pest or parasite is growing or may grow.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “cultivated plants” is to be understood as including plants which have been modified by breeding, mutagenesis or genetic engineering. Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transtional modification of protein(s) (oligo- or polypeptides) poly for example by glycosylation or polymer additions such as prenylated, acetylated or farnesylated moieties or PEG moieties (e.g. as disclosed in Biotechnol Prog. 2001 July-August; 17(4):720-8., Protein Eng Des Sel. 2004 January; 17(1):57-66, Nat Protoc. 2007; 2(5):1225-35., Curr Opin Chem Biol. 2006 October; 10(5):487-91. Epub 2006 Aug. 28., Biomaterials. 2001 March; 22(5):405-17, Bioconjug Chem. 2005 January-February; 16(1):113-21).

The term “cultivated plants” is to be understood also including plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A-0242236, EP-A-242246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e.g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” is to be understood also including plants that are by the use of recombinant DNA techniques capable to synthesize one or more insecticidal proteins, especially those known from the bacterial genus Bacillus, particularly from Bacillus thuringiensis, such as ä-endotoxins, e.g. CryIA(b), CryIA(c), CryIF, CryIF(a2), CryIIA(b), CryIIIA, CryIIB(b1) or Cry9c; vegetative insecticidal proteins (VIP), e.g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically-modified plants capable of synthesizing such toxins are dis-closed, for example, in EP-A 374 753, WO 93/007278, WO 95/34656, EP-A 427 529, EP-A 451 878, WO 03/018810 and WO 03/052073. The methods for producing such genetically modified plants are generally known to the person skilled in the art and are described, for example, in the publications mentioned above. These insecticidal proteins contained in the genetically modified plants impart to the plants producing these proteins protection from harmful pests from certain taxonomic groups of arthropods, particularly to beetles (Coleoptera), flies (Diptera), and butterflies and moths (Lepidoptera) and to plant parasitic nematodes (Nematoda).

The term “cultivated plants” is to be understood also including plants that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, for example EP-A 0 392 225), plant disease resistance genes (for example potato cultivars, which express resistance genes acting against Phytophthora infestans derived from the mexican wild potato Solanum bulbocastanum) or T4-lyso-zym (e.g. potato cultivars capable of synthesizing these proteins with increased resistance against bacteria such as Erwinia amylvora). The methods for producing such genetically modified plants are generally known to the person skilled in the art and are described, for example, in the publications mentioned above.

The term “cultivated plants” is to be understood also including plants that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

The term “cultivated plants” is to be understood also including plants that contain by the use of recombinant DNA techniques a modified amount of substances of content or new substances of content, specifically to improve human or animal nutrition, for ex-ample oil crops that produce health-promoting long-chain omega-3 fatty acids or unsaturated omega-9 fatty acids (e.g. Nexera® rape).

The term “cultivated plants” is to be understood also including plants that contain by the use of recombinant DNA techniques a modified amount of substances of content or new substances of content, specifically to improve raw material production, for example potatoes that produce increased amounts of amylopectin (e.g. Amflora® potato).

In general, “pesticidally effective amount” means the amount of active ingredient needed to achieve an observable effect on growth, including the effects of necrosis, death, retardation, prevention, and removal, destruction, or otherwise diminishing the occurrence and activity of the target organism. The pesticidally effective amount can vary for the various compounds/compositions used in the invention. A pesticidally effective amount of the compositions will also vary according to the prevailing conditions such as desired pesticidal effect and duration, weather, target species, locus, mode of application, and the like.

In the case of soil treatment or of application to the pests dwelling place or nest, the quantity of active ingredient ranges from 0.0001 to 500 g per 100 m², preferably from 0.001 to 20 g per 100 m².

Seed Treatment

The compounds of formula I are also suitable for the treatment of seeds in order to protect the seed from insect pest, in particular from soil-living insect pests and the resulting plant's roots and shoots against soil pests and foliar insects.

The compounds of formula I are particularly useful for the protection of the seed from soil pests and the resulting plant's roots and shoots against soil pests and foliar insects. The protection of the resulting plant's roots and shoots is preferred. More preferred is the protection of resulting plant's shoots from piercing and sucking insects, wherein the protection from aphids is most preferred.

The present invention therefore comprises a method for the protection of seeds from insects, in particular from soil insects and of the seedling's roots and shoots from insects, in particular from soil and foliar insects, said method comprising contacting the seeds before sowing and/or after pregermination with a compound of the general formula I or a salt thereof. Particularly preferred is a method, wherein the plant's roots and shoots are protected, more preferably a method, wherein the plants shoots are protected form piercing and sucking insects, most preferably a method, wherein the plants shoots are protected from aphids.

The term seed embraces seeds and plant propagules of all kinds including but not limited to true seeds, seed pieces, suckers, corms, bulbs, fruit, tubers, grains, cuttings, cut shoots and the like and means in a preferred embodiment true seeds.

The term seed treatment comprises all suitable seed treatment techniques known in the art, such as seed dressing, seed coating, seed dusting, seed soaking and seed pelleting.

The present invention also comprises seeds coated with or containing the active compound.

The term “coated with and/or containing” generally signifies that the active ingredient is for the most part on the surface of the propagation product at the time of application, although a greater or lesser part of the ingredient may penetrate into the propagation product, depending on the method of application. When the said propagation product is (re)planted, it may absorb the active ingredient.

Suitable seed is seed of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

In addition, the active compound may also be used for the treatment seeds from plants, which tolerate the action of herbicides or fungicides or insecticides owing to breeding, including genetic engineering methods.

For example, the active compound can be employed in treatment of seeds from plants, which are resistant to herbicides from the group consisting of the sulfonylureas, imidazolinones, glufosinate-ammonium or glyphosate-isopropylammonium and analogous active substances (see for example, EP-A-0242236, EP-A-242246) (WO 92/00377) (EP-A-0257993, U.S. Pat. No. 5,013,659) or in transgenic crop plants, for example cotton, with the capability of producing Bacillus thuringiensis toxins (Bt toxins) which make the plants resistant to certain pests (EP-A-0142924, EP-A-0193259),

Furthermore, the active compound can be used also for the treatment of seeds from plants, which have modified characteristics in comparison with existing plants consist, which can be generated for example by traditional breeding methods and/or the generation of mutants, or by recombinant procedures). For example, a number of cases have been described of recombinant modifications of crop plants for the purpose of modifying the starch synthesized in the plants (e.g. WO 92/11376, WO 92/14827, WO 91/19806) or of transgenic crop plants having a modified fatty acid composition (WO 91/13972).

The seed treatment application of the active compound is carried out by spraying or by dusting the seeds before sowing of the plants and before emergence of the plants.

Compositions which are especially useful for seed treatment are e.g.:

A Soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-Formulations (GF)

I Dustable powders (DP, DS)

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter

In a preferred embodiment a FS formulation is used for seed treatment. Typically, a FS formulation may comprise 1-800 g/l of active ingredient, 1-200 g/l Surfactant, 0 to 200 g/l antifreezing agent, 0 to 400 g/l of binder, 0 to 200 g/l of a pigment and up to 1 liter of a solvent, preferably water.

Especially preferred FS formulations of compounds of formula I for seed treatment usually comprise from 0.1 to 80% by weight (1 to 800 g/l) of the active ingredient, from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

Seed Treatment formulations may additionally also comprise binders and optionally colorants.

Binders can be added to improve the adhesion of the active materials on the seeds after treatment. Suitable binders are homo- and copolymers from alkylene oxides like ethylene oxide or propylene oxide, polyvinylacetate, polyvinylalcohols, polyvinylpyrrolidones, and copolymers thereof, ethylene-vinyl acetate copolymers, acrylic homo- and copolymers, polyethyleneamines, polyethyleneamides and polyethyleneimines, polysaccharides like celluloses, tylose and starch, polyolefin homo- and copolymers like olefin/maleic anhydride copolymers, polyurethanes, polyesters, polystyrene homo and copolymers

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of a Gelling Agent is Carrageen (Satiagel®)

In the treatment of seed, the application rates of the compounds I are generally from 0.1 g to 10 kg per 100 kg of seed, preferably from 1 g to 5 kg per 100 kg of seed, more preferably from 1 g to 1000 g per 100 kg of seed and in particular from 1 g to 200 g per 100 kg of seed.

The invention therefore also relates to seed comprising a compound of the formula I, or an agriculturally useful salt of I, as defined herein. The amount of the compound I or the agriculturally useful salt thereof will in general vary from 0.1 g to 10 kg per 100 kg of seed, preferably from 1 g to 5 kg per 100 kg of seed, in particular from 1 g to 1000 g per 100 kg of seed. For specific crops such as lettuce the rate can be higher.

Pests

The invention in particular relates to soil application methods for combating soil-living arthropod pests, and nematode pests, which comprises applying to the soil a pesticidally effective amount of a compound of the present invention.

The term “soil-living” means that the habitat, breeding ground, area or environment in which a pest or parasite is growing or may grow is the soil.

The use of the compounds according to the present invention extends to a wide range of different animal pests, especially soil living pests. These include but are not limited to, the following families:

Insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia munnana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetna bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantna cunea, Hyponomeuta malinelus, Keifena lycopersicella, Lambdina fiscellaria, Laphygma exigua, Leucoptera coffeella, Leucoptera scitella, Lithocolletis blancardella, Lobesia botrana, Loxostege sticticalis, Lymantna dispar, Lymantna monacha, Lyonetia clerkella, Malacosoma neustria, Mamestra brassicae, Orgyia pseudotsugata, Ostrinia nubllalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pillenana, Spodoptera frugiperda, Spodoptera littoralis, Spodoptera litura, Thaumatopoea pityocampa, TortriX viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomana Blastophagus piniperda, Blitophaga undata, Byctiscus betulae, Cassida nebulosa, Cerotoma trifurcata, Cetonia aurata, Ceuthorrhynchus assimilis, Ceuthorrhynchus nap, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Hylobius abietis, Hypera brunneipennis, Hypera postica, Ips typographus, Lema bilineata, Lema melanopus, Leptinotarsa decemlineata, Lirnonius califormicus, Lissorhoptrus oryzophilus, Melanotus communis, Meligethes aeneus, Melolontha hippocastani, Melolontha melolontha, Oulema oryzae, Otiorrhynchus sulcatus, Otiorrhynchus ovatus, Phaedon cochleanae, Phyllobius pyri, Phyllotreta chrysocephala, Phyllophaga sp., Phyllopertha horticola, Phyllotreta nemorum, Phyllotreta striolata, Popaa kaponica, Sitona lineatus and,

flies, mosquitoes (Diptera), e.g. Ceratitis capitata, Contarinia sorghicola Dacus cucurbitae, Dacus oleae, Dasineura brassicae, Delia antique, Delia coarctata, Delia platura, Delia radicum, Liriomyza sativae, Liriomyza Oscinella frit, Pegomya hysocyami, Phorbia antiqua, Phorbia brassicae, Phorbia coarctata, Psila rosae, Psorophora discolor, Rhagoletis ceras, Rhagoletis pomonella, Tipula oleracea, and Tipula paludosa

trips (Thysanoptera), e.g. Dichromothrips corbetti, Dichromothrips ssp., Frankliniella fusca, Frankliniella occidentalis, Frankliniella tritici, Scirtothrips citri, Thrips oryzae, Thrips palmi and Thrips tabaci,

termites (Isoptera), e.g. Calotermes flavicollis, Leucotermes flavipes, Heterotermes aureus, Reticulitermes flavipes, Reticulitermes virginicus, Reticulitermes lucifugus, Reticulitermes santonensis, Reticulitermes grassei, Termes natalensis, and Coptotermes formosanus,

bugs, aphids, leafhoppers, whiteflies, scale insects, cicadas (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onobrychis, Adelges laricis, Aphidula nasturtii, Aphis fabae, Aphis forbesi, Aphis pony, Aphis gossypii, Aphis grossulanae, Aphis schneideri, Aphis spiraecola, Aphis sambuci, Acyrthosiphon pisum, Aulacorthum solani, Bemisia argentifolii, Brachycaudus cardui, Brachycaudus helichrysi Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis gyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mak, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, Viteus vitifolii, Cimex lectularius, Cimex hemipterus, Reduvius sendis, Triatoma spp., and Arilus critatus.

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Lasius niger, Monomorium pharaonis, Solenopsis geminata, Solenopsis invicta, Solenopsis richteri, Solenopsis xyloni, Pogonomyrmex barbatus, Pogonomyrmex califormicus, Pheidole megacephala, Dasymutfila occidentalis, Polistes rubiginosa, Camponotus floridanus, and Linepithema humile,

crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina,

Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophllus annulatus, Boophllus decoloratus, Boophllus microplus, Dermacentor siivarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni, Tarsonemidae spp. such as Phytonemus pallidus and Polyphagotarsonemus latus; Tenuipalpidae spp. such as Brevipalpus phoenicis, Tetranychidae spp. such as Tetranychus cinnabarinus, Tetranychus kanzawai, Tetranychus pacificus, Tetranychus tetanus and Tetranychus urticae, Panonychus ulmi, Panonychus citri, and Oligonychus pratensis; Araneida, e.g. Latrodectus mactans, and Loxosceles reclusa,

Other preferred animal pests to be controlled and combated by the methods of the present invention are:

From the family of the Pemphigidae, the following species are preferred: Eriosoma spp., Pemphigus spp., Anuraphis spp., Brachycaudus spp., in crops such as, for example, pome fruit, conifers, vegetables and ornamentals.

From the psyllid family (Psyllidae), the following species are preferred: Psylla spp., Paratrioza spp., Trioza spp., in crops such as, for example, citrus, vegetables, potatoes, pome fruit.

From the scale insect family (Coccidae), the following species are preferred: Ceroplastes spp., Drosicha spp. Pulvinaria spp., Protopuhninana spp., Saissetia spp., Coccus spp., in perennial crops such as, for example, citrus, grapevines, tea, pome and stone fruit, tropical crops, ornamentals, conifers, but also vegetables.

From the family of the Diaspididae, the following are preferred: Quadraspidiotus spp., Aonidiella spp., Lepidosaphes spp., Aspidiotus spp., Aspis spp., Diaspis spp., Parlatoria spp., Pseudaulacaspis spp., Unaspis spp., Pinnaspis spp., Selenaspidus spp., in crops such as, for example, citrus, tea, ornamentals, conifers, pome and stone fruit, grapevines, tropical crops.

From the family of the Pseudococcidae, the following species are preferred: Pericerga, Pseudococcus spp., Planococcus spp., Phenacoccus spp., Dysmicoccus spp., in crops such as, for example, citrus, pome and stone fruit, tea, grapevines, vegetables, ornamentals, conifers, spices and tropical crops.

Furthermore preferred are the following species from the family of the Aleyrodidae: Bemisia argentifolii, Bemisia tabaci, Trialeurodes vaporariorum, Aleurothrixus floccosus, Aleurodes spp., Dialeurodes spp., Parabemisia myricae in crops such as, for example, vegetables, melons, potatoes, tobacco, soft fruit, citrus, ornamentals, conifers, cotton, potatoes and tropical crops.

Furthermore preferred species are the following from the family of the Aphidae:

Myzus spp. in tobacco, stone fruit, pome fruit, soft fruit, Brassica vegetables, fruiting vegetables, leafy vegetables, tuber and root vegetables, melons, potatoes, spices, ornamentals and conifers.

Aphis spp. in cotton, tobacco, citrus, melons, beet, soft fruit, oilseed rape, fruiting vegetables, leafy vegetables, Brassica vegetables, tuber and root vegetables, ornamentals, potatoes, pumpkins, spices. Rhodobium porosum in strawberries, Nasonovia ribisnigri in leafy vegetables,

Macrosiphum spp. in ornamentals, cereals, potatoes, leafy vegetables, Brassica vegetables and fruiting vegetables, strawberries, Phorodon humuli in hops, Toxoptera spp. in citrus, stone fruit, almonds, nuts, cereals, spices,

Aulacorthum spp. in citrus, potatoes, fruiting vegetables and leafy vegetables.

Preferred species are furthermore the following from the family of the Tetranychidae: Tetranychus spp., Brevipalpus spp., Panonychus spp., Oligonycbus spp., Eotetranychus spp., Bryobia spp. in crops such as, for example, vegetables, ornamentals, spices, conifers, citrus, stone and pome fruit, grapevines, cotton, soft fruit, melons, potatoes.

The following are preferred species from the family of the Tarsonemidae:

Hermitarsonernus batus, Stenotarsonemus spp., Polyphagotarsonemus spp., Stenotarsonemus spinki in crops such as, for example, vegetables, ornamentals, spices, conifers, tea, citrus, melons.

Furthermore preferred species are the following from the thrips family (Thripidae): Anaphothrips spp., Baliothrips spp., Caliothrips spp., Frariklirúella spp., Heliothrips spp., Hercrnothrips spp., Rhipiphorothrips spp., Scirtothrips spp., Selenothrips spp. and Thrips spp., in crops such as, for example, fruit, cotton, grapevines, soft fruit, vegetables, melons, ornamentals, spices, conifers, tropical crops, tea.

Also preferred species are the following from the whitefly family (Agromyzidae): Liriomyza spp., Pegomya spp. in crops such as, for example, vegetables, melons, potatoes and ornamentals.

Also preferred species are the following from the foliar nematode family (Aphelenchoididae), for example Aphelenchoides ritzemabosi, A. fragariae, A. besseyi, A. blastophthorus in crops such as soft fruits and ornamentals.

Most preferably the methods of the present invention are applied to control and combat arachnids, especially the following ones from the family of the Tetranychidae:

Tetranychus spp., Brevipalpus spp., Panonychus spp., Oligonycbus spp., Eotetranychus spp. and Bryobia spp.

Preferred compounds for soil application methods

With regard to their use in the soil application methods of the present invention, preferably compounds of formula (I) are applied, wherein the substituents are selected as defined hereinbelow.

Preferred are compounds of formula (I), wherein R¹ is 2,2,2-trifluoroethyl.

Preferred are compounds of formula (I), wherein R² is selected from chlorine, methyl, difluoromethyl, trifluoromethyl or cyano.

Preferred are compounds of formula (I), wherein R² is methyl.

Preferred are compounds of formula (I), wherein R³ is selected from hydrogen, fluorine, chlorine, methyl or trifluoromethyl.

Preferred are compounds of formula (I), wherein R³ is fluorine.

Especially preferred are compounds I of formula (I), wherein R² is selected from chlorine, methyl, difluoromethyl, trifluoromethyl or cyano and R³ is selected from hydrogen, fluorine, chlorine, methyl or trifluoromethyl.

Especially more preferred are compounds I of formula (I), wherein R³ is fluorine and R² is methyl.

In one preferred embodiment of the compound of formula (I) k is 0.

In another preferred embodiment of the compound I of formula (I) k is 1, 2 or 3, and R⁴ is selected independently from the integer of k from fluorine, chlorine, CN, NO₂, methyl, trifluoromethyl, methoxy difluoromethoxy or trifluoromethoxy.

Especially preferred are compounds of formula (I-A):

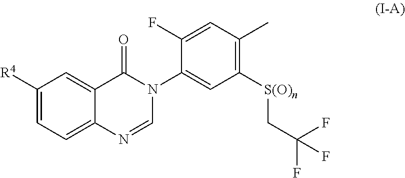

wherein R⁴ is selected from fluorine, chlorine, methyl, trifluoromethyl, methoxy, difluoromethoxy and trifluoromethoxy,

and

wherein n is 0 or 1.

Especially preferred are compounds formula (I-A-1):

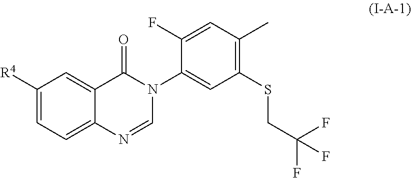

wherein R⁴ is selected from fluorine, chlorine, methyl, trifluoromethyl, methoxy, difluoromethoxy and trifluoromethoxy.

Especially preferred are compounds formula (I-A-2):

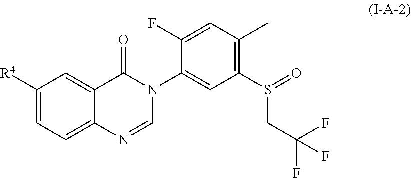

wherein R⁴ is selected from fluorine, chlorine, methyl, trifluoromethyl, methoxy, difluoromethoxy and trifluoromethoxy.

The compounds of formula I-A-2 carry a chiral sulfoxide group, so that they form two enantiomers with R- or S-configuration at the sulphur atom:

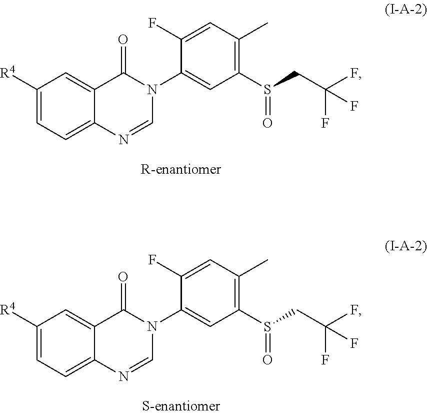

Both enantiomers as well as a mixture of both enantiomers, or a racemate are especially preferred compounds of the invention.

Especially preferred are compounds of formula (I-B):

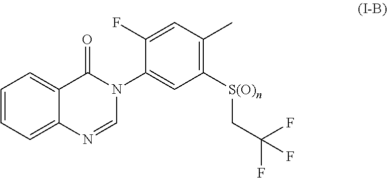

wherein n is 0 or 1.

Especially preferred is the compound of formula (I-B-1):

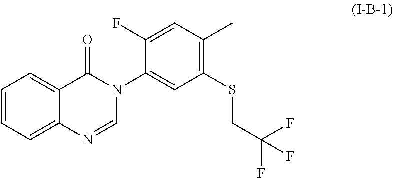 [SMILES: Cc1cc(F)c(-n2cnc3ccccc3c2=O)cc1SCC(F)(F)F]

Especially preferred is the compound of formula (I-B-2):

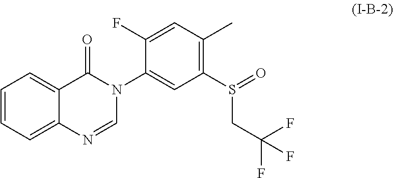 [SMILES: Cc1cc(F)c(-n2cnc3ccccc3c2=O)cc1S(=O)CC(F)(F)F]

The compound of formula (I-B-2) carries a chiral sulfoxide group, so that it forms the following two enantiomers with R- or S-configuration at the sulphur atom:

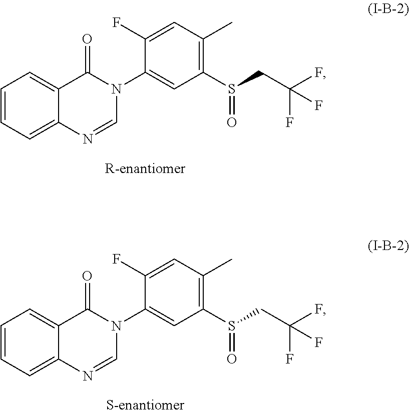 [SMILES: Cc1cc(F)c(-n2cnc3ccccc3c2=O)cc1[S@](=O)CC(F)(F)F ; Cc1cc(F)c(-n2cnc3ccccc3c2=O)cc1[S@@](=O)CC(F)(F)F]

Both enantiomers as well as a mixture of both enantiomers, or a racemate are a especially preferred compounds of the invention.

Further examples of especially preferred compounds used in soil application methods of the present invention are compounds of formula (I-C)

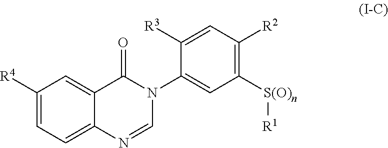

wherein the meanings of substituents R¹, R² and R³ are given in one row of the following table C.I.1:

Further examples of especially preferred compounds used in soil application methods of the present invention are compounds of formula (I-C-a)

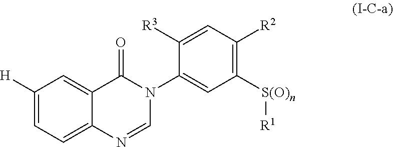

wherein the meanings of substituents R¹, R² and R³ are given in one row of the following table C.I.1.

Further examples of especially preferred compounds used in soil application methods of the present invention are compounds of formula (I-C-b)

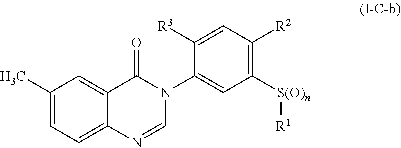

wherein the meanings of substituents R¹, R² and R³ are given in one row of the following table C.I.1.

Further examples of especially preferred compounds used in soil application methods of the present invention are compounds of formula (I-C-c)

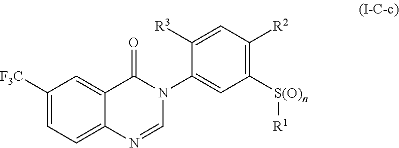

wherein the meanings of substituents R¹, R² and R³ are given in one row of the following table C.I.1.

Further examples of especially preferred compounds used in soil application methods of the present invention are compounds of formula (I-C-d)

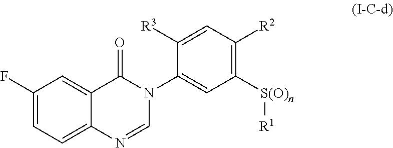

wherein the meanings of substituents R¹, R² and R³ are given in one row of the following table C.I.1.

Further examples of especially preferred compounds used in soil application methods of the present invention are compounds of formula (I-C-e)

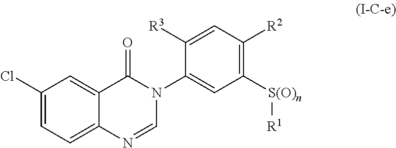

wherein the meanings of substituents R¹, R² and R³ are given in one row of the following table C.I.1.

Further examples of especially preferred compounds used in soil application methods of the present invention are compounds of formula (I-C-f)

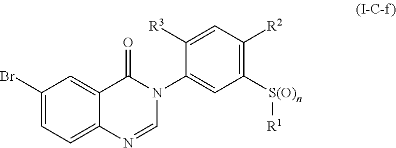

wherein the meanings of substituents R¹, R² and R³ are given in one row of the following table C.I.1.

Further examples of especially preferred compounds used in soil application methods of the present invention are compounds of formula (I-C-g)

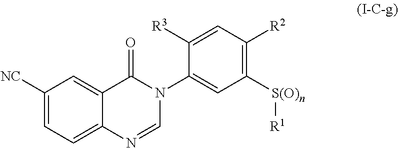

wherein the meanings of substituents R¹, R² and R³ are given in one row of the following table C.I.1.

Further examples of especially preferred compounds used in soil application methods of the present invention are compounds of formula (I-C-h)

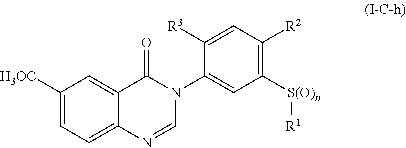

wherein the meanings of substituents R¹, R² and R³ are given in one row of the following table C.I.1.

Further examples of especially preferred compounds used in soil application methods of the present invention are compounds of formula (I-C-i)

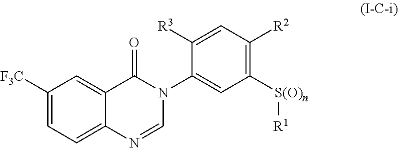

wherein the meanings of substituents R¹, R² and R³ are given in one row of the following table C.I.1.

Further examples of especially preferred compounds used in soil application methods of the present invention are compounds of formula (I-C-j)

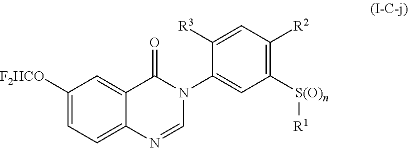

wherein the meanings of substituents R¹, R² and R³ are given in one row of the following table C.I.1.

TABLE C.I.1

| Comp. | | | | |
|---|---|---|---|---|
| C.I | n | R¹ | R² | R³ |
| C.I.1 | 0 | F₃C—CH₂ | Cl | H |
| C.I.2 | 0 | F₃C—CH₂ | CH₃ | H |
| C.I.3 | 0 | F₃C—CH₂ | CHF₂ | H |
| C.I.4 | 0 | F₃C—CH₂ | CF₃ | H |
| C.I.5 | 0 | F₃C—CH₂ | CN | H |
| C.I.6 | 0 | F₃C—CH₂ | Cl | F |
| C.I.7 | 0 | F₃C—CH₂ | CH₃ | F |
| C.I.8 | 0 | F₃C—CH₂ | CHF₂ | F |
| C.I.9 | 0 | F₃C—CH₂ | CF₃ | F |
| C.I.10 | 0 | F₃C—CH₂ | CN | F |
| C.I.11 | 0 | F₃C—CH₂ | Cl | Cl |
| C.I.12 | 0 | F₃C—CH₂ | CH₃ | Cl |
| C.I.13 | 0 | F₃C—CH₂ | CHF₂ | Cl |
| C.I.14 | 0 | F₃C—CH₂ | CF₃ | Cl |
| C.I.15 | 0 | F₃C—CH₂ | CN | Cl |
| C.I.16 | 0 | F₃C—CH₂ | Cl | CH₃ |
| C.I.17 | 0 | F₃C—CH₂ | CH₃ | CH₃ |
| C.I.18 | 0 | F₃C—CH₂ | CHF₂ | CH₃ |
| C.I.19 | 0 | F₃C—CH₂ | CF₃ | CH₃ |
| C.I.20 | 0 | F₃C—CH₂ | CN | CH₃ |
| C.I.21 | 0 | F₃C—CH₂ | Cl | CF₃ |
| C.I.22 | 0 | F₃C—CH₂ | CH₃ | CF₃ |
| C.I.23 | 0 | F₃C—CH₂ | CHF₂ | CF₃ |
| C.I.24 | 0 | F₃C—CH₂ | CF₃ | CF₃ |
| C.I.25 | 0 | F₃C—CH₂ | CN | CF₃ |
| C.I.26 | 1 | F₃C—CH₂ | Cl | H |
| C.I.27 | 1 | F₃C—CH₂ | CH₃ | H |
| C.I.28 | 1 | F₃C—CH₂ | CHF₂ | H |
| C.I.29 | 1 | F₃C—CH₂ | CF₃ | H |
| C.I.30 | 1 | F₃C—CH₂ | CN | H |
| C.I.31 | 1 | F₃C—CH₂ | Cl | F |
| C.I.32 | 1 | F₃C—CH₂ | CH₃ | F |
| C.I.33 | 1 | F₃C—CH₂ | CHF₂ | F |
| C.I.34 | 1 | F₃C—CH₂ | CF₃ | F |
| C.I.35 | 1 | F₃C—CH₂ | CN | F |
| C.I.36 | 1 | F₃C—CH₂ | Cl | Cl |
| C.I.37 | 1 | F₃C—CH₂ | CH₃ | Cl |
| C.I.38 | 1 | F₃C—CH₂ | CHF₂ | Cl |
| C.I.39 | 1 | F₃C—CH₂ | CF₃ | Cl |
| C.I.40 | 1 | F₃C—CH₂ | CN | Cl |
| C.I.41 | 1 | F₃C—CH₂ | Cl | CH₃ |
| C.I.42 | 1 | F₃C—CH₂ | CH₃ | CH₃ |
| C.I.43 | 1 | F₃C—CH₂ | CHF₂ | CH₃ |
| C.I.44 | 1 | F₃C—CH₂ | CF₃ | CH₃ |
| C.I.45 | 1 | F₃C—CH₂ | CN | CH₃ |
| C.I.46 | 1 | F₃C—CH₂ | Cl | CF₃ |
| C.I.47 | 1 | F₃C—CH₂ | CH₃ | CF₃ |
| C.I.48 | 1 | F₃C—CH₂ | CHF₂ | CF₃ |
| C.I.49 | 1 | F₃C—CH₂ | CF₃ | CF₃ |
| C.I.50 | 1 | F₃C—CH₂ | CN | CF₃ |

The examples of preferred 3-arylquinazolin-4-onederivatives given herein above are relate to the form of their isomer mixtures or their pure isomers.

Preparation of the compounds of formula I, including the preferred compounds of the present invention, can be accomplished according to standard methods of organic chemistry, e.g. by the methods or working examples described in WO2010/100189 without being limited to the routes given therein.

In one embodiment of the invention, the pesticidal compound can be combined and used in mixture with another active compound applied in agriculture. Preferably that other compound is active against said soil-living arthropod pest. A skilled person is familiar with such compounds and knows which compounds are active against a specific target organism.

The following list M of pesticides together with which the compounds according to the invention can be used and with which potential synergistic effects might be produced, is intended to illustrate the possible combinations, but not to impose any limitation:

M.1. Organo(thio)phosphate compounds: acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-5-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;

M.2. Carbamate compounds: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate;

M.3. Pyrethroid compounds: acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zetacypermethrin, cyphenothrin, deltamethrin, empenthrin, esfenvalerate, ethofenprox, fenpropathrin, fenvalerate, flucythrinate, flumethrin, tau-fluvalinate, halfenprox, imiprothrin, metofluthrin, permethrin, phenothrin, prallethrin, profluthrin, pyrethrin (pyrethrum), resmethrin, silafluofen, tefluthrin, tetramethrin, tralomethrin, transfluthrin;

M.4. Juvenile hormone mimics: hydroprene, kinoprene, methoprene, fenoxycarb, pyriproxyfen;

M.5. Nicotinic receptor agonists/antagonists compounds: acetamiprid, bensultap, cartap hydrochloride, clothianidin, dinotefuran, imidacloprid, thiamethoxam, nitenpyram, nicotine, spinosad (allosteric agonist), spinetoram (allosteric agonist), thiacloprid, thiocyclam, thiosultap-sodium and AKD1022.

M.6. GABA gated chloride channel antagonist compounds: chlordane, endosulfan, gamma-HCH (lindane); ethiprole, fipronil, pyrafluprole, pyriprole

M.7. Chloride channel activators: abamectin, emamectin benzoate, milbemectin, lepimectin;

M.8. METI I compounds: fenazaquin, fenpyroximate, pyrimidifen, pyridaben, tebufenpyrad, tolfenpyrad, flufenerim, rotenone;

M.9. METI II and III compounds: acequinocyl, fluacyprim, hydramethylnon;

M.10. Uncouplers of oxidative phosphorylation: chlorfenapyr, DNOC;

M.11. Inhibitors of oxidative phosphorylation: azocyclotin, cyhexatin, diafenthiuron, fenbutatin oxide, propargite, tetradifon;

M.12. Moulting disruptors: cyromazine, chromafenozide, halofenozide, methoxyfenozide, tebufenozide;

M.13. Synergists: piperonyl butoxide, tribufos;

M.14. Sodium channel blocker compounds: indoxacarb, metaflumizone;

M.15. Fumigants: methyl bromide, chloropicrin sulfuryl fluoride;

M.16. Selective feeding blockers: pymetrozine, flonicamid;

M.17. Mite growth inhibitors: clofentezine, hexythiazox, etoxazole;

M.18. Chitin synthesis inhibitors: buprofezin, bistrifluoron, chlorfluazuron, diflubenzuron, flucycloxuron, flufenoxuron, hexaflumuron, lufenuron, novaluron, noviflumuron, teflubenzuron, triflumuron;

M.19. Lipid biosynthesis inhibitors: spirodiclofen, spiromesifen, spirotetramat;

M.20. Octapaminergic agonsits: amitraz;

M.21. Ryanodine receptor modulators: flubendiamide and the phtalamid compound (R)-, (S)-3-Chlor-N1-{2-methyl-4-[1,2,2,2-tetrafluor-1-(trifluormethyl)ethyl]phenyl}-N2-(1-methyl-2-methylsulfonylethyl)phthalamid (M21.1)

M.22. Other isoxazoline compounds: 4-[5-(3,5-Dichloro-phenyl)-5-trifluoromethyl-4,5-dihydro-isoxazol-3-yl]-2-methyl-N-pyridin-2-ylmethyl-benzamide (M22.1), 4-[5-(3,5-Dichloro-phenyl)-5-trifluoromethyl-4,5-dihydro-isoxazol-3-yl]-2-methyl-N-(2,2,2-trifluoro-ethyl)-benzamide (M22.2), 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide (M22.3), 4-[5-(3,5-Dichloro-phenyl)-5-trifluoromethyl-4,5-dihydro-isoxazol-3-yl]-naphthalene-1-carboxylic acid [(2,2,2-trifluoro-ethylcarbamoyl)-methyl]-amide (M22.4) 4-[5-(3,5-Dichlorophenyl)-5-trifluoromethyl-4,5-dihydro-isoxazol-3-yl]-N-[(methoxyimino)methyl]-2-methylbenzamide (M22.5), 4-[5-(3-Chloro-5-trifluoromethyl-phenyl)-5-trifluoromethyl-4,5-dihydro-isoxazol-3-yl]-2-methyl-N-[(2,2,2-trifluoroethyl-carbamoyl)-methyl]-benzamide (M22.6), 4-[5-(3-Chloro-5-trifluoromethyl-phenyl)-5-trifluoromethyl-4,5-dihydro-isoxazol-3-yl]-naphthalene-1-carboxylic acid [(2,2,2-trifluoro-ethylcarbamoyl)-methyl]-amide (M22.7) and 5-[5-(3,5-Dichloro-4-fluorophenyl)-5-trifluoromethyl-4,5-dihydro-isoxazol-3-yl]-2-[1,2,4]triazol-1-yl-benzonitrile (M22.8);

M.23. Anthranilamide compounds: chloranthraniliprole, cyantraniliprole, 5-Bromo-2-(3-chloro-pyridin-2-yl)-2H-pyrazole-3-carboxylic acid [4-cyano-2-(1-cyclopropyl-ethylcarbamoyl)-6-methyl-phenyl]-amide (M23.1), 5-Bromo-2-(3-chloro-pyridin-2-yl)-2H-pyrazole-3-carboxylic acid [2-chloro-4-cyano-6-(1-cyclopropyl-ethylcarbamoyl)-phenyl]-amide (M23.2), 5-Bromo-2-(3-chloro-pyridin-2-yl)-2H-pyrazole-3-carboxylic acid [2-bromo-4-cyano-6-(1-cyclopropyl-ethylcarbamoyl)-phenyl]amide (M23.3), 5-Bromo-2-(3-chloro-pyridin-2-yl)-2H-pyrazole-3-carboxylic acid [2-bromo-4-chloro-6-(1-cyclopropyl-ethylcarbamoyl)-phenyl]-amide (M23.4), 5-Bromo-2-(3-chloro-pyridin-2-yl)-2H-pyrazole-3-carboxylic acid [2,4-dichloro-6-(1-cyclopropyl-ethylcarbamoyl)-phenyl]-amide (M23.5), 5-Bromo-2-(3-chloro-pyridin-2-yl)-2H-pyrazole-3-carboxylic acid [4-chloro-2-(1-cyclopropyl-ethylcarbamoyl)-6-methyl-phenyl]-amide (M23.6), N′-(2-{[5-Bromo-2-(3-chloro-pyridin-2-yl)-2H-pyrazole-3-carbonyl]-amino}-5-chloro-3-methyl-benzoyl)-hydrazinecarboxylic acid methyl ester (M23.7), N′-(2-{[5-Bromo-2-(3-chloro-pyridin-2-yl)-2H-pyrazole-3-carbonyl]-amino}-5-chloro-3-methyl-benzoyl)-N′-methyl-hydrazinecarboxylic acid methyl ester (M23.8), N′-(2-{[5-Bromo-2-(3-chloro-pyridin-2-yl)-2H-pyrazole-3-carbonyl]-amino}-5-chloro-3-methyl-benzoyl)-N,N′-dimethyl-hydrazinecarboxylic acid methyl ester (M23.9), N′-(3,5-Dibromo-2-{[5-bromo-2-(3-chloro-pyridin-2-yl)-2H-pyrazole-3-carbonyl]-amino}-benzoyl)-hydrazinecarboxylic acid methyl ester (M23.10), N′-(3,5-Dibromo-2-{[5-bromo-2-(3-chloro-pyridin-2-yl)-2H-pyrazole-3-carbonyl]-amino}-benzoyl)-N′-methyl-hydrazinecarboxylic acid methyl ester (M23.11) and N′-(3,5-Dibromo-2-{[5-bromo-2-(3-chloro-pyridin-2-yl)-2H-pyrazole-3-carbonyl]-amino}-benzoyl)-N,N′-dimethyl-hydrazinecarboxylic acid methyl ester (M23.12);

M.24. Malononitrile compounds: 2-(2,2,3,3,4,4,5,5-octafluoropentyl)-2-(3,3,3-trifluoropropyl)malononitrile (CF₂H—CF₂—CF₂—CF₂—CH₂—C(CN)₂—CH₂—CH₂—CF₃) (M24.1) and 2-(2,2,3,3,4,4,5,5-octafluoropentyl)-2-(3,3,4,4,4-pentafluorobutyl)-malonodinitrile (CF₂H—CF₂—CF₂—CF₂—CH₂—C(CN)₂—CH₂—CH₂—CF₂—CF₃) (M24.2);

M.25. Microbial disruptors: Bacillus thuringiensis subsp. Israelensi, Bacillus sphaericus, Bacillus thuringiensis subsp. Aizawai, Bacillus thuringiensis subsp. Kurstaki, Bacillus thuringiensis subsp. Tenebrionis;

M.26. Aminofuranone compounds: 4-{[(6-Bromopyrid-3-yl)methyl](2-fluoroethyl)amino}furan-2(5H)-on (M26.1), 4-{[(6-Fluoropyrid-3-yl)methyl](2,2-difluoroethyl)amino}furan-2(5H)-on (M26.2), 4-{[(2-Chloro1,3-thiazolo-5-yl)methyl](2-fluoroethyl)amino}furan-2(5H)-on (M26.3), 4-{[(6-Chloropyrid-3-yl)methyl](2-fluoroethyl)amino}furan-2(5H)-on (M26.4), 4-{[(6-Chloropyrid-3-yl)methyl](2,2-difluoroethyl)amino}furan-2(5H)-on (M26.5), 4-{[(6-Chloro-5-fluoropyrid-3-yl)methyl](methyl)amino}furan-2(5H)-on (M26.6), 4-{[(5,6-Dichloropyrid-3-yl)methyl](2-fluoroethyl)amino}furan-2(5H)-on (M26.7), 4-{[(6-Chloro-5-fluoropyrid-3-yl)methyl](cyclopropyl)amino}furan-2(5H)-on (M26.8), 4-{[(6-Chloropyrid-3-yl)methyl](cyclopropyl)amino}furan-2(5H)-on (M26.9) and 4-{[(6-Chloropyrid-3-yl)methyl](methyl)amino}furan-2(5H)-on (M26.10);

M.27. Various compounds: aluminium phosphide, amidoflumet, benclothiaz, benzoximate, bifenazate, borax, bromopropylate, cyanide, cyenopyrafen, cyflumetofen, chinomethionate, cryolite, dicofol, fluensulfone, fluoroacetate, phosphine, pyridalyl, pyrifluquinazon, sulfur, organic sulfur compounds, tartar emetic, sulfoxaflor, N—R′-2,2-dihalo-1-R″cyclo-propanecarboxamide-2-(2,6-dichloro-α,α,α-trifluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl, 4-But-2-ynyloxy-6-(3,5-dimethyl-piperidin-1-yl)-2-fluoro-pyrimidine (M27.1), [(3S,4R,4aR,6S,6aS,12R,12aS,12bS)-3-(cyclopropanecarbonyloxy)-6,12-dihydroxy-4,6a,12b-trimethyl-11-oxo-9-(pyridin-3-yl)-1,2,3,4,4a,5,6,6a,12a,12b-decahydro-11H,12H-benzo[f]pyrano[4,3-b]chromen-4-yl]methyl cyclopropanecarboxylate (M27.2) and 8-(2-Cyclopropylmethoxy-4-trifluoromethyl-phenoxy)-3-(6-trifluoromethyl-pyridazin-3-yl)-3-aza-bicyclo[3.2.1]octane (M27.3).

The commercially available compounds of the group M may be found in The Pesticide Manual, 13th Edition, British Crop Protection Council (2003) among other publications.

Paraoxon and their preparation have been described in Farm Chemicals Handbook, Volume 88, Meister Publishing Company, 2001. Flupyrazofos has been described in Pesticide Science 54, 1988, p. 237-243 and in U.S. Pat. No. 4,822,779. AKD 1022 and its preparation have been described in U.S. Pat. No. 6,300,348. The anthranilamides M23.1 to M23.6 have been described in WO 2008/72743 and WO 200872783, those M23.7 to M23.12 in WO2007/043677. The phthalamide M 21.1 is known from WO 2007/101540. The alkynylether compound M27.1 is described e.g. in JP 2006131529. Organic sulfur compounds have been described in WO 2007060839. The isoxazoline compounds M 22.1 to M 22.8 have been described in e.g. WO2005/085216, WO 2007/079162, WO 2007/026965, WO 2009/126668 and WO2009/051956. The aminofuranone compounds M 26.1 to M 26.10 have been described eg. in WO 2007/115644. The pyripyropene derivative M 27.2 has been described in WO 2008/66153 and WO 2008/108491. The pyridazin compound M 27.3 has been described in JP 2008/115155. Malononitrile compounds as those (M24.1) and (M24.2) have been described in WO 02/089579, WO 02/090320, WO 02/090321, WO 04/006677, WO 05/068423, WO 05/068432 and WO 05/063694.

The following list of active fungicidal substances, in conjunction with which the compounds according to the invention also can be used, is intended to illustrate the possible combinations but does not limit them:

F.I) Respiration Inhibitors

F.I-1) Inhibitors of complex III at Qo site (e.g. strobilurins) strobilurins: azoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, methyl (2-chloro-5 [1-(3-methylbenzyloxyimino)ethyl]benzyl)carbamate and 2 (2-(3-(2,6-dichlorophenyl)-1-methyl-allylideneaminooxymethyl)-phenyl)-2-methoxyimino-N methyl-acetamide; oxazolidinediones and imidazolinones: famoxadone, fenamidone;

F.I-2) Inhibitors of complex II (e.g. carboxamides):

carboxanilides: benodanil, bixafen, boscalid, carboxin, fenfuram, fenhexamid, fluopyram, flutolanil, furametpyr, isopyrazam, isotianil, mepronil, oxycarboxin, penflufen, penthiopyrad, sedaxane, tecloftalam, thifluzamide, tiadinil, 2-amino-4 methyl-thiazole-5-carboxanilide, N-(3′,4′,5′ trifluorobiphenyl-2 yl)-3-difluoromethyl-1-methyl-1H-pyrazole-4 carboxamide, N-(4′-trifluoromethylthiobiphenyl-2-yl)-3 difluoromethyl-1-methyl-1H pyrazole-4-carboxamide and N-(2-(1,3,3-trimethyl-butyl)-phenyl)-1,3-dimethyl-5 fluoro-1H-pyrazole-4 carboxamide;

F.I-3) Inhibitors of complex III at Qi site: cyazofamid, amisulbrom;

F.I-4) Other respiration inhibitors (complex I, uncouplers)

diflumetorim; tecnazen; ferimzone; ametoctradin; silthiofam;

nitrophenyl derivates: binapacryl, dinobuton, dinocap, fluazinam, nitrthal-isopropyl, organometal compounds: fentin salts, such as fentin-acetate, fentin chloride or fentin hydroxide;

F.II) Sterol biosynthesis inhibitors (SBI fungicides)

F.II-1) C14 demethylase inhibitors (DMI fungicides, e.g. triazoles, imidazoles) triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole; imidazoles: imazalil, pefurazoate, oxpoconazole, prochloraz, triflumizole; pyrimidines, pyridines and piperazines: fenarimol, nuarimol, pyrifenox, triforine;

F.II-2) Delta14-reductase inhitors (Amines, e.g. morpholines, piperidines) morpholines: aldimorph, dodemorph, dodemorph-acetate, fenpropimorph, tridemorph;

piperidines: fenpropidin, piperalin;

spiroketalamines: spiroxamine;

F.II-3) Inhibitors of 3-keto reductase: hydroxyanilides: fenhexamid;

F.III) Nucleic acid synthesis inhibitors

F.III-1) RNA, DNA synthesis

phenylamides or acyl amino acid fungicides: benalaxyl, benalaxyl-M, kiralaxyl, metalaxyl, metalaxyl-M (mefenoxam), ofurace, oxadixyl;

isoxazoles and iosothiazolones: hymexazole, octhilinone;

F.III-2) DNA topisomerase inhibitors: oxolinic acid;

F.III-3) Nucleotide metabolism (e.g. adenosin-deaminase) hydroxy (2-amino)-pyrimidines: bupirimate;

F.IV) Inhibitors of cell division and or cytoskeleton

F.IV-1) Tubulin inhibitors: benzimidazoles and thiophanates: benomyl, carbendazim, fuberidazole, thiabendazole, thiophanate-methyl;

triazolopyrimidines: 5-chloro-7 (4-methylpiperidin-1-yl)-6-(2,4,6-trifluorophenyl)-[1,2,4]triazolo[1,5a]pyrimidine

F.IV-2) Other cell division inhibitors

benzamides and phenyl acetamides: diethofencarb, ethaboxam, pencycuron, fluopicolide, zoxamide;

F.IV-3) Actin inhibitors: benzophenones: metrafenone;

F.V) Inhibitors of amino acid and protein synthesis

F.V-1) Methionine synthesis inhibitors (anilino-pyrimidines)

anilino-pyrimidines: cyprodinil, mepanipyrim, nitrapyrin, pyrimethanil;

F.V-2) Protein synthesis inhibitors (anilino-pyrimidines)

antibiotics: blasticidin-S, kasugamycin, kasugamycin hydrochloride-hydrate, mildiomycin, streptomycin, oxytetracyclin, polyoxine, validamycin A;

F.VI) Signal transduction inhibitors

F.VI-1) MAP/Histidine kinase inhibitors (e.g. anilino-pyrimidines) dicarboximides: fluoroimid, iprodione, procymidone, vinclozolin;

phenylpyrroles: fenpiclonil, fludioxonil;

F.VI-2) G protein inhibitors: quinolines: quinoxyfen;

F.VII) Lipid and membrane synthesis inhibitors

F.VII-1) Phospholipid biosynthesis inhibitors

organophosphorus compounds: edifenphos, iprobenfos, pyrazophos;

dithiolanes: isoprothiolane;

F.VII-2) Lipid peroxidation

aromatic hydrocarbons: dicloran, quintozene, tecnazene, tolclofos-methyl, biphenyl, chloroneb, etridiazole;

F.VII-3) Carboxyl acid amides (CAA fungicides)

cinnamic or mandelic acid amides: dimethomorph, flumorph, mandiproamid, pyrimorph;

valinamide carbamates: benthiavalicarb, iprovalicarb, pyribencarb, valifenalate and N-(1-(1-(4-cyano-phenyl)ethanesulfonyl)-but-2-yl) carbamic acid-(4-fluorophenyl)ester;
F.VII-4) Compounds affecting cell membrane permeability and fatty acides carbamates: propamocarb, propamocarb-hydrochlorid

F.VIII) Inhibitors with Multi Site Action

F.VIII-1) Inorganic active substances: Bordeaux mixture, copper acetate, copper hydroxide, copper oxychloride, basic copper sulfate, sulfur;

F.VIII-2) Thio- and dithiocarbamates: ferbam, mancozeb, maneb, metam, methasulphocarb, metiram, propineb, thiram, zineb, ziram;

F.VIII-3) Organochlorine compounds (e.g. phthalimides, sulfamides, chloronitriles):

anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-N-ethyl-4-methyl-benzenesulfonamide;

F.VIII-4) Guanidines: guanidine, dodine, dodine free base, guazatine, guazatineacetate, iminoctadine, iminoctadine-triacetate, iminoctadine-tris(albesilate);

F.VIII-5) Ahtraquinones: dithianon;

F.IX) Cell wall synthesis inhibitors

F.IX-1) Inhibitors of glucan synthesis: validamycin, polyoxin B;

F.IX-2) Melanin synthesis inhibitors: pyroquilon, tricyclazole, carpropamide, dicyclomet, fenoxanil;

F.X) Plant defence inducers

F.X-1) Salicylic acid pathway: acibenzolar-S-methyl;

F.X-2) Others: probenazole, isotianil, tiadinil, prohexadione-calcium;

phosphonates: fosetyl, fosetyl-aluminum, phosphorous acid and its salts;

F.XI) Unknown mode of action:

bronopol, chinomethionat, cyflufenamid, cymoxanil, dazomet, debacarb, diclomezine, difenzoquat, difenzoquat-methylsulfate, diphenylamin, flumetover, flusulfamide, flutianil, methasulfocarb, oxin-copper, proquinazid, tebufloquin, tecloftalam, triazoxide, 2-butoxy-6-iodo-3-propylchromen-4-one, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2 methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide, 3-[5-(4-chloro-phenyl)-2,3-dimethyl-isoxazolidin-3 yl]-pyridine, 3-[5-(4-methyl-phenyl)-2,3-dimethyl-isoxazolidin-3-yl]-pyridine, 5-amino-2-isopropyl-3-oxo-4-ortho-tolyl-2,3-dihydro-pyrazole-1 carbothioic acid S-allyl ester, N-(6-methoxy-pyridin-3-yl)cyclopropanecarboxylic acid amide, 5-chloro-1 (4,6-dimethoxy-pyrimidin-2-yl)-2-methyl-1H-benzoimidazole, 2-(4-chlorophenyl)-N-[4-(3,4-dimethoxy-phenyl)-isoxazol-5-yl]-2-prop-2-ynyloxy-acetamide;

F.XI) Growth regulators:

abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N 6 benzyladenine, paclobutrazol, prohexadione (prohexadione-calcium), prohydrojasmon, thidiazuron, triapenthenol, tributyl phosphorotrithioate, 2,3,5 tri iodobenzoic acid, trinexapac-ethyl and uniconazole;

F.XII) Biological control agents

antifungal biocontrol agents: Bacillus substilis strain with NRRL No. B-21661 (e.g. RHAPSODY®, SERENADE® MAX and SERENADE® ASO from AgraQuest, Inc., USA.), Bacillus pumilus strain with NRRL No. B-30087 (e.g. SONATA® and BALLAD® Plus from AgraQuest, Inc., USA), Ulocladium oudemansii (e.g. the product BOTRYZEN from BotriZen Ltd., New Zealand), Chitosan (e.g. ARMOUR-ZEN from BotriZen Ltd., New Zealand).

### EXAMPLES

The present invention is now illustrated in further detail by the following examples.

The compounds I of formula I can be accomplished according to standard methods of organic chemistry, e.g. by the methods or working examples described in WO 2010/100189.

Some of the preferred compound I examples are characterized in following table CE.I.1 and further by their physical data in the subsequent table CE.I.1-D.1.

The characterization can be done by coupled High Performance Liquid Chromatography/mass spectrometry (HPLC/MS), by NMR or by their melting points.

The compounds I were characterized by ¹H-NMR spectroscopy. The signals are characterized by chemical shift (ppm) vs. tetramethylsilane, by their multiplicity and by their integral (relative number of hydrogen atoms given). The following abbreviations are used to characterize the multiplicity of the signals: M=multiplett, q=quartett, t=triplett, d=doublet and s=singulett.

The compounds I were also characterized by LC-MS (High Performance Liquid Chromatography Mass Spectrometry HPLC/MS). The compounds I of formula I were preferably characterized by HPLC, which was carried out using an analytic RP-18 column (Chromolith Speed ROD from Merck KGaA, Germany) which was operated at 40° C. Acetonitrile with 0.1% by volume of a trifluoroacetic acid/water mixture and 0.1% by volume of trifluoroacetic acid served as mobile phase; flow rate: 1.8 mL/min and injection volume: 2 μl.

Some specific compound examples of arylquinazolinone compounds I of formula (I)

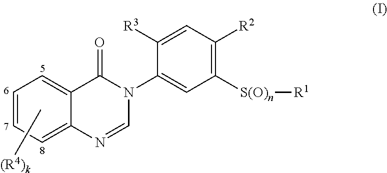

of the present invention are listed in table CE.1 hereinafter, and their respective physical date are provided in subsequent table CE-D.1:

TABLE CE.I.1*

| Compound | (R⁴)ₖ | R³ | R² | R¹ | n |
|---|---|---|---|---|---|
| CE.I.1. | k = 0 | F | CH₃ | CF₃—CH₂— | 2 |
| CE.I.2. | k = 0 | F | CH₃ | n-propyl | 0 |
| CE.I.3. | k = 0 | F | CH₃ | n-propyl | 1 |
| CE.I.4. | 8-CH₃ | F | CH₃ | CF₃—CH₂— | 0 |
| CE.I.5. | 8-CH₃ | F | CH₃ | CF₃—CH₂— | 1 |
| CE.I.6. | 8-Cl | F | CH₃ | CF₃—CH₂— | 0 |
| CE.I.7. | 8-Cl | F | CH₃ | CF₃—CH₂— | 1 |
| CE.I.8. | k = 0 | F | CH₃ | 3,4,4-trifluoro-3-buten-1-yl | 0 |
| CE.I.9. | k = 0 | F | CH₃ | 3,4,4-trifluoro-3-buten-1-yl | 1 |
| CE.I.10. | k = 0 | H | CH₃ | CF₃—CH₂— | 0 |
| CE.I.11. | k = 0 | H | CH₃ | CF₃—CH₂— | 1 |
| CE.I.12. | k = 0 | F | CH₃ | cyclopropylmethyl | 0 |
| CE.I.13. | k = 0 | F | CH₃ | cyclopropylmethyl | 1 |
| CE.I.14. | 6-Cl | F | CH₃ | CF₃—CH₂— | 0 |
| CE.I.15. | 6-Cl | F | CH₃ | CF₃—CH₂— | 1 |
| CE.I.16. | 7-CH₃ | F | CH₃ | CF₃—CH₂— | 0 |
| CE.I.17. | 7-CH₃ | F | CH₃ | CF₃—CH₂— | 1 |
| CE.I.18. | 7-Cl | F | CH₃ | CF₃—CH₂— | 0 |
| CE.I.19. | 7-Cl | F | CH₃ | CF₃—CH₂— | 1 |
| CE.I.20. | 6-OCH₃ | F | CH₃ | CF₃—CH₂— | 0 |
| CE.I.21. | 6-OCH₃ | F | CH₃ | CF₃—CH₂— | 1 |
| CE.I.22. | 5-CH₃ | F | CH₃ | CF₃—CH₂— | 0 |
| CE.I.23. | 5-CH₃ | F | CH₃ | CF₃—CH₂— | 1 |
| CE.I.24. | 6-CH₃ | F | CH₃ | CF₃—CH₂— | 0 |
| CE.I.25. | 6-CH₃ | F | CH₃ | CF₃—CH₂— | 1 |
| CE.I.26. | 5-Cl | F | CH₃ | CF₃—CH₂— | 0 |
| CE.I.27. | 5-Cl | F | CH₃ | CF₃—CH₂— | 1 |
| CE.I.28. | k = 0 | CH₃ | CH₃ | CF₃—CH₂— | 0 |
| CE.I.29. | k = 0 | CH₃ | CH₃ | CF₃—CH₂— | 1 |
| CE.I.30. | 6-F | F | CH₃ | CF₃—CH₂— | 0 |
| CE.I.31. | 6-F | F | CH₃ | CF₃—CH₂— | 1 |
| CE.I.32. | 6-CF₃O | F | CH₃ | CF₃—CH₂— | 0 |
| CE.I.33. | 6-CF₃O | F | CH₃ | CF₃—CH₂— | 1 |
| CE.I.34. | k = 0 | F | CH₃ | CF₃—CH₂— | 0 |
| CE.I.35. | k = 0 | F | CH₃ | CF₃—CH₂— | 1 |

*some compound examples of table CE.I.1 have also been described as preferred compounds I of the present invention in table C.I.1;

TABLE CE.I.1.-D.1

| Compound | Physico-chemical data: ¹H-NMR (400 MHz) δ or r.t. [min]/M⁺ |
|---|---|
| CE.I.1. | 3.13 min/400.05 |
| CE.I.2. | CDCl₃: δ = 8.39~8.36 (m, 1H), 8.01 (s, 1H), 7.84~7.77 (m, 2H), |
| | 7.58~7.54 (m, 1H), 7.28~7.25 (m, 1H), 7.17 (d, 1H, J = 10.4 Hz), |
| | 2.88~2.84 (m, 2H), 2.45 (s, 3H), 1.74~1.65 (m, 2H), 1.06~1.04 |
| | (m, 3H) |
| CE.I.3. | CDCl₃: δ = 8.37~8.35 (m, 1H), 8.01 (s, 1H), 8.01 (s, 1H), 7.98 (d, |
| | 1H, J = 7.0 Hz), 7.85~7.78 (m, 2H), 7.59~7.55 (m, 1H), 7.18 (d, |
| | 1H, J = 10 Hz), 2.86~2.72 (m, 2H), 2.46 (s, 3H), 1.94~1.73 (m, |
| | 2H), 1.25 (s, 3H) |
| CE.I.4. | CD₃OD: δ = 8.19 (s, 1H), 8.13~8.11 (m, 1H), 7.78 (d, 1H, J = 7.2 |
| | Hz), 7.33 (d, 1H, J = 10.8 Hz), 3.73~3.66 (m, 2H), 2.64 (s, 3H), |
| | 2.56 (s, 3H) |
| CE.I.5. | CDCl₃: δ = 8.13 (d, 1H, J = 8 Hz), 8.01 (d, 1H, J = 7.2 Hz), 7.94 |
| | (s, 1H), 7.62 (d, 1H, J = 7.2 Hz), 7.41~7.31 (m, 1H), 7.19~7.17 |
| | (m, 1H), 3.48~3.40 (m, 2H), 2.6 (s, 3H), 2.42 (s, 3H) |
| CE.I.6. | CD₃OD: δ = 8.29 (s, 1H), 8.24~8.21 (m, 1H), 7.99~7.97 (m, 1H), |
| | 7.80 (d, 1H, J = 7.2 Hz), 7.58~7.54 (m, 1H), 7.35~7.32 (m, 1H), |
| | 3.73~3.66 (m, 2H), 2.56 (s, 3H) |
| CE.I.7. | CD₃OD: δ = 8.36 (s, 1H), 8.25~8.23 (m, 1H), 8.12 (d, 1H, J = 7.2 |
| | Hz), 8.01~7.99 (m, 1H), 7.60~7.55 (m, 1H), 7.46~7.45 (m, 1H), |
| | 4.09~3.84 (m, 2H), 2.53 (s, 3H) |
| CE.I.8. | CDCl₃: δ = 8.31~8.29 (m, 1H), 7.93 (s, 1H), 7.78~7.70 (m, 2H), |
| | 7.52~7.48 (m, 1H), 7.30~7.28 (d, 1H, J = 7.2 Hz), 7.12~7.1 (d, |
| | 1H, J = 10 Hz), 3.01~2.98 (m, 2H), 2.61~2.50 (m, 2H), 2.41 (s, |
| | 3H) |
| CE.I.9. | CDCl₃: δ = 8.36 (t, 1H, J = 0.8 Hz), 8.02 (d, 1H, J = 0.8 Hz), 8.00 |
| | (d, 1H, J = 7.2 Hz), 7.61~7.56 (m, 1H), 7.23 (d, 1H, J = 9.6 Hz), |
| | 3.15~3.11 (m, 1H), 3.09~2.87 (m, 2H), 2.87~2.68 (m, 1H), 2.47 |
| | (s, 3H) |
| CE.I.10. | DMSO-d₆: δ = 8.32 (s, 1H), 8.21 (d, 1H, J = 8 Hz), 7.90~7.88 (m, |
| | 1H), 7.46-7.23 (m, 2H), 7.63~7.61 (m, 1H), 7.45-7.43 (m, 1H), |
| | 7.37 (dd, 1H, J = 1 Hz, 8 Hz), 4.08-4.06 (m, 2H), 2.42 (s, 3H) |
| CE.I.11. | DMSO-d₆: δ = 8.41 (s, 1H), 8.22 (d, J = 8 Hz), 7.91 (dd, 1H, J = |
| | 1.6 Hz, 7.6 Hz), 7.89 (d, 1H, J = 7.6 Hz), 7.78-7.70 (m, 2H), 7.64- |
| | 7.55 (m, 2H), 7.26-7.04 (m, 2H), 2.32 (s, 3H) |
| CE.I.12. | CDCl₃: δ = 8.14 (d, 1H, J = 9.2 Hz), 7.79 (s, 1H), 7.59~7.54 (m, |
| | 2H), 7.35~7.13 (m, 1H), 7.08 (d, 1H, J = 7.2 Hz), 6.91 (d, 1H, J = |
| | 12.4 Hz), 2.58 (d, 1H, J = 6.8 Hz), 2.24 (s, 3H), 0.82~0.80 (m, |
| | 1H), 0.39~0.34 (m, 2H), 0.04~0.03 (m, 2H) |
| CE.I.13. | CDCl₃: δ = 8.36~8.34 (m, 1H), 8.02~8.00 (m, 2H), 7.83~7.78 (m, |
| | 2H), 7.58 (t, 1H, J = 5.6 Hz), 7.17 (d, 1H, J = 10.4 Hz), 2.81~2.75 |
| | (m, 2H), 2.46 (s, 3H), 1.10~1.086 (m, 1H), 0.71~0.66 (m, 2H), |
| | 0.31~0.28 (m, 2H) |
| CE.I.14. | CDCl₃: δ = 8.25 (d, 1H, J = 2.4 Hz), 7.910 (s, 1H), 7.707~7.647 |
| | (m, 2H), 7.51 (d, 1H, J = 7.2 Hz), 7.16 (t, 1H, J = 11.2 Hz), |
| | 3.341~3.269 (m, 2H), 2.500 (s, 3H) |
| CE.I.15. | CDCl₃: δ = 8.24 (d, 1H, J = 2.8 Hz), 8.010~7.923 (m, 1H), 7.921 |
| | (s, 1H), 7.724~7.663 (m, 2H), 7.206~7.181 (m, 1H), 3.478~3.404 |
| | (m, 2H), 2.425 (s, 3H) |
| CE.I.16. | CD₃OD: δ = 8.25 (d, 1H, J = 8 Hz), 7.97 (d, 1H, J = 0.8 Hz), |
| | 7.61~7.58 (m, 2H), 7.41~7.39 (m, 1H), 7.23~7.21 (m, 1H) |
| | 3.43~3.36 (m, 2H), 2.58 (s, 3H), 2.56 (s, 3H) |
| CE.I.17. | CDCl₃: δ = 8.24 (d, 1H, J = 8 Hz), 8.09 (d, 1H, J = 7.2 Hz), 7.99 |
| | (s, 1H), 7.59 (s, 1H), 7.42~7.39 (m, 1H), 7.26 (d, 1H, J = 10.4 |
| | Hz), 3.57~3.48 (m, 2H), 2.56 (s, 3H), 2.50 (s, 3H) |
| CE.I.18. | CDCl₃: δ = 8.22 (d, 1H, J = 7.6 Hz), 7.93 (s, 1H), 7.71 (d, 1H, J = |
| | 2 Hz), 7.51 (d, 1H, J = 7.2 Hz), 7.46~7.44 (m, 1H), 7.15 (d, 1H, J = |
| | 10 Hz), 3.34~3.27 (m, 2H), 2.5 (s, 3H) |
| CE.I.19. | CDCl₃: δ = 8.33 (s, 1H), 8.27 (d, 1H, J = 8.8 Hz), 8.10 (d, 1H, J = |
| | 7.6 Hz), 7.80 (d, 1H, J = 2 Hz), 7.64~7.62 (m, 1H), 7.45 (d, 1H, J = |
| | 10.4 Hz), 4.02~3.89 (m, 2H), 2.53 (s, 3H) |
| CE.I.20. | CDCl₃: δ = 7.92 (d, 1H, J = 1.2 Hz), 7.92~7.72 (m, 2H), 7.60 (d, |
| | 1H, J = 7.2 Hz), 7.44~7.41 (m, 1H), 7.28 (s, 1H), 7.23 (d, 1H, J = |
| | 10.4 Hz), 3.95 (s, 3H), 3.43~3.36 (m, 2H), 2.58 (s, 3H) |
| CE.I.21. | CDCl₃: δ = 8.10 (d, 1H, J = 7.2 Hz), 7.93 (s, 1H), 7.75~7.07 (m, |
| | 2H), 7.45~7.42 (m, 1H), 7.27 (d, 1H, J = 8.8 Hz), 3.95 (s, 3H), |
| | 3.57~3.50 (m, 2H), 2.51 (s, 3H) |
| CE.I.22. | CDCl₃: δ = 7.95 (s, 1H), 7.67~7.61 (m, 2H), 7.57 (d, 1H, J = 7.2 |
| | Hz), 7.32 (d, 1H, J = 7.2 Hz), 7.20 (d, 1H, J = 10.4 Hz), 3.41~3.34 |
| | (m, 2H), 2.87 (s, 3H), 2.56 (s, 3H) |
| CE.I.23. | CDCl₃: δ = 8.07~8.05 (m, 1H), 7.95 (d, 1H, J = 0.8 Hz), 7.69~7.61 |
| | (m, 2H), 7.34~7.32 (m, 1H), 7.25~7.23 (m, 1H), 3.56~3.45 (m, |
| | 2H), 2.87 (s, 3H) 2.48 (s, 3H) |
| CE.I.24. | CDCl₃: δ = 8.14 (s, 1H), 7.94 (s, 1H), 7.69~7.62 (m, 2H), 7.58 (d, |
| | 1H, J = 7.6 Hz), 7.21 (d, 1H, J = 10 Hz), 3.41~3.34 (m, 2H), 2.56 |
| | (s, 3H), 2.52 (s, 3H) |
| CE.I.25. | CDCl₃: δ = 8.25 (s, 1H), 8.14 (d, 2H, J = 7.2 Hz), 7.74~7.76 (m, |
| | 1H), 7.70~7.68 (m, 1H), 7.46~7.43 (m, 1H), 4.06~3.88 (m, 2H), |
| | 2.53 (s, 6H) |
| CE.I.26. | CDCl₃: δ = 7.99 (d, 1H, J = 0.8 Hz), 7.67~7.66 (m, 2H), 7.61~7.56 |
| | (m, 2H), 7.22 (d, 1H, J = 10 Hz), 3.43~3.35 (m, 2H), 2.58 (s, 3H) |
| CE.I.27. | CDCl₃: δ = 8.07 (d, 1H, J = 7.2 Hz), 7.98 (d, 1H, J = 0.8 Hz), |
| | 7.70~7.69 (m, 2H), 7.59~7.56 (m, 1H), 7.25~7.23 (m, 1H), 2.49 |
| | (s, 3H) |
| CE.I.28. | 3.62 min/365.05 |
| CE.I.29. | 2.75 min/380.90 |
| CE.I.30. | ¹H NMR (400 MHz, DMSO-d6): δ 8.40 (s, 1 H), 7.94-7.80 (m, |
| | 4H), 7.49 (d, J = 10.5 Hz, 1H), 4.04 (q, J_{H-F} = 10.2 Hz, 2H), 2.49 |
| | (s, 3H) |
| CE.I.31. | ¹H NMR (400 MHz, DMSO-d6): δ 8.41 (s, 1 H), 8.13 (d, J = 7.4 |
| | Hz, 1H), 7.94-7.86 (m, 2H), 7.85-7.79 (m, 1H), 7.58 (d, J = 10.7 |
| | Hz, 1H), 4.28-4.02 (m, 2H), 2.50 (s, 3H) |
| CE.I.32. | ¹H NMR (400 MHz, CDCl₃): δ 8.13 (s, 1H), 8.00 (s, 1H), 7.79 (d, |
| | J = 9.2 Hz, 1H), 7.65-7.60 (m, 2H), 7.20 (d, J = 10.1 Hz, 1H), 3.40 |
| | (q, J_{H-F} = 9.4 Hz, 2H), 2.55 (s, 3H) |
| CE.I.33. | ¹H NMR (400 MHz, DMSO-d6): δ 8.50 (s, 1 H), 8.16 (d, J = 7.4 |
| | Hz, 1H), 8.06 (broad s, 1H), 7.94 (broad s, 2H), 7.61 (d, J = 10.7 |
| | Hz, 1H), 4.33-4.02 (m, 2H), 2.50 (s, 3H). |
| CE.I.34. | ¹H NMR (400 MHz, CDCl₃): δ = 8.28-8.31 (m, 1H), 7.94 (s, 1H), |
| | 7.71-7.78 (m, 2H), 7.48-7.53 (m, 2H), 7.13-7.16 (m, 1H), 3.27- |
| | 3.34 (m, 2H), 2.50 (s, 3H). |
| CE.I.35. | ¹H NMR (400 MHz, CDCl₃): δ = 8.34-8.36 (m, 1H), 8.08 (d, 1H, |
| | J = 7.2 Hz), 8.02 (s, 1H), 7.48-7.53 (m, 2H), 7.79-7.87 (m, 2H), |
| | 7.56-7.6 (m, 1H), 7.24-7.26 (m, 1H), 3.47-3.55 (m, 2H), 2.49 (s, |
| | 3H). |

### S. Synthesis Examples

### S.1 6-Fluoro-3-[2-fluoro-4-methyl-5-2(2,2,2-trifluoroethylsulfanyl)-phenyl]-3H-quinazolin-4-one

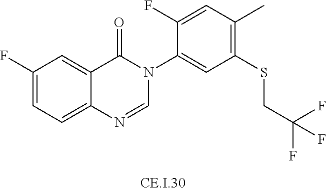 [SMILES: Cc1cc(F)c(-n2cnc3ccc(F)cc3c2=O)cc1SCC(F)(F)F]

### 1.1 3-Acetamino-4-fluoro-6-methyl-phenylsulfonyl chloride

To a solution of 2-fluoro-4-methyl-aniline (250 g, 2 mol) and triethylamine (202 g, 2 mol) in 2 L of dichloromethane was added dropwise acetyl chloride (156 g, 2 mol). The reaction mixture was stirred for 2 hours at a temperature of 0° C. and subsequently washed with dilute hydrochloric acid. The organic phase was dried with sodium sulfate and concentrated under reduced pressure to yield 2-fluoro-4-methyl-acetanilide as a crude intermediate (334 g, 87%).

To 546 g (3.27 mol) of crude 2-fluoro-4-methyl-acetanilide was added chlorosulphonic acid (2000 g, 17.24 mol) with stirring at a temperature below 70° C. Stirring was continued for 3 hours at a temperature of 70° C. The reaction mixture was poured onto ice and then extracted with ethyl acetate. The organic phase was dried with sodium sulfate and concentrated under reduced pressure to yield the title compound (500 g, 57.8%).

¹H NMR (400 MHz, CDCl₃): δ=9.1 (d, 1H, J=7.2 Hz), 7.39-7.52 (m, 1H), 7.14 (d, 1H, J=11.2 Hz), 2.72-2.78 (m, 3H), 2.2-2.3 (m, 3H).

### 1.2 3-(2,2,2-Trifluoroethylsulfanyl)-4-methyl-6-fluoroaniline

3-Acetamino-4-fluoro-6-methyl-phenylsulfonylchloride (500 g, 1.89 mol) was dissolved in 2 L of acetic acid. Red phosphorus (100 g, 3.22 mmol) and iodine (10 g, 39 mmol) were added to the solution, and the mixture was refluxed for 3 hours. The acetic acid was removed under reduced pressure, water was added and the residue extracted with ethyl acetate. The organic phase was dried with sodium sulfate and concentrated under reduced pressure to give 5-acetamino-4-fluoro-2-methyl-benzenethiol as a crude intermediate (270 g, 72%).

Crude 5-acetamino-4-fluoro-2-methyl-benzenethiol (280 g, 1.41 mol) was added to a 5% (w/w) solution of potassium hydroxide (250 g, 4.46 mol) in water and the mixture was refluxed for 5 hours. The resulting solution was adjusted to pH 7 with dilute hydrochloric acid and was then extracted with ethyl acetate. The organic phase was dried with sodium sulfate and concentrated under reduced pressure to give 5-amino-4-fluoro-2-methyl-benzenethiol as a crude intermediate (160 g, 88%).

¹H NMR (400 MHz, CDCl₃): δ=7.18 (d, 1H, J=1.6 Hz), 6.66-6.74 (m, 2H), 3.2-3.67 (m, 2H), 3.03-3.14 (m, 1H), 2.10-2.15 (m, 3H).

To a solution of potassium hydroxide (78.5 g, 1.4 mol), sodium hydroxymethylsulfinate (Rongalite®, 74.4 g, 0.63 mol) and the crude 5-amino-4-fluoro-2-methyl-benzenethiol (110 g, 0.7 mol) in 380 mL of DMF was added dropwise 2,2,2-trifluoroethyl iodide (147.1 g, 0.704 mol). The reaction mixture was stirred for 2 hours at room temperature, poured into water and then extracted with ethyl acetate. The organic phase was dried with sodium sulfate and concentrated under reduced pressure to yield the title compound (176 g, 99%). ¹H NMR (400 MHz, CDCl3): δ=6.84-6.89 (m, 1H), 6.7-6.78 (m 1H), 3.4-3.7 (m, 3H), 3.14-3.25 (m, 2H), 2.22-2.26 (m, 3H).

### 1.3 N-(2-Nitro-5-fluoro-benzoyl)-3-(2,2,2-trifluoroethylsulfanyl)-4-methyl-6-fluoro-anilide

To a solution of 3-(2,2,2-trifluoroethylsulfanyl)-4-methyl-6-fluoro-aniline (4.0 g, 16.7 mmol) in 100 mL DMF was added 2-Nitro-5-fluorobenzoic acid (3.09 g, 16.7 mmol), triethylamine (2.02 g, 20 mmol) and HATU (7.6 g, 20 mmol) and the resulting mixture was stirred overnight at room temperature. Water (300 mL) was then added and the reaction mixture was extracted with ethyl acetate (3×100 mL). The organic phase was washed with water (100 mL) and brine (100 mL), dried over magnesium sulfate, filtered and concentrated under reduced pressure. The crude product was purified by column chromatography on silica gel eluting with a gradient of ethyl acetate/cyclohexane to afford the title compound (5.00 g, 74%) as a yellow solid.

### 1.4 N-(2-amino-5-fluoro-benzoyl)-3-(2,2,2-trifluoroethylsulfanyl)-4-methyl-6-fluoro-anilide

To a suspension of N-(2-nitro-5-fluoro-benzoyl)-3-(2,2,2-trifluoroethylsulfanyl)-4-methyl-6-fluoro-anilide (5.0 g, 12.3 mmol) in 87 mL ethanol was added Raney nickel (1.0 g) and the stirred mixture was hydrogenated at ambient pressure overnight at room temperature. The solid was filtered off and the filtrate was evaporated to give the intermediate N-(2-amino-5-fluoro-benzoyl)-3-(2,2,2-trifluoroethylsulfanyl)-4-methyl-6-fluoro-anilide (4.6 g, 99%) as a white solid.

### 1.5 6-Fluoro-3-[2-fluoro-4-methyl-5-2(2,2,2-trifluoroethylsulfanyl)-phenyl]-3H-quinazolin-4-one

A mixture of N-(2-amino-5-fluoro-benzoyl)-3-(2,2,2-trifluoroethylsulfanyl)-4-methyl-6-fluoro-anilide (4.0 g, 10.6 mmol), concentrated sulfuric acid (0.24 mL, 4.5 mmol) and 1,1,1-triethoxymethane (23 g) were heated to 140° C. and stirred for 3 hours at this temperature. The mixture was cooled to room temperature, excess of solvent was removed under reduced pressure and the crude product was purified by column chromatography on silica gel eluting with a gradient of ethyl acetate/cyclohexane to afford the title compound 1-1 (1.8 g, 44%) as a white solid.

¹H NMR (400 MHz, DMSO-d6): δ 8.40 (s, 1H), 7.94-7.80 (m, 4H), 7.49 (d, J=10.5 Hz, 1H), 4.04 (q, =10.2 Hz, 2H), 2.49 (s, 3H)

### S.2 6-Fluoro-3-[2-fluoro-4-methyl-5-2(2,2,2-trifluoroethanesulfinyl)-phenyl]-3H-quinazolin-4-one

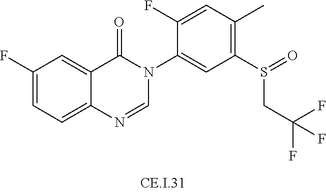 [SMILES: Cc1cc(F)c(-n2cnc3ccc(F)cc3c2=O)cc1S(=O)CC(F)(F)F]

To a solution of 6-fluoro-3-[2-fluoro-4-methyl-5-2(2,2,2-trifluoroethylsulfanyl)phenyl]-3H-quinazolin-4-one I-1 (1.0 g, 2.59 mmol) in 100 mL chloroform at 0° C. was added m-chloroperoxybenzoic acid (m-CPBA) (0.58 g, 2.59 mmol, 77% purity) and the reaction mixture was stirred for 3 hours at 0° C. The reaction mixture was then washed with a saturated solution of sodium thiosulfate (100 mL) and a saturated solution of sodium hydrogencarbonate (100 mL). The organic phase was separated, dried over magnesium sulfate, filtered and concentrated under reduced pressure. Recrystallization from hot ethanol afforded the title compound I-2 (0.76 g, 73%) as a white solid.

¹H NMR (400 MHz, DMSO-d6): δ 8.41 (s, 1H), 8.13 (d, J=7.4 Hz, 1H), 7.94-7.86 (m, 2H), 7.85-7.79 (m, 1H), 7.58 (d, J=10.7 Hz, 1H), 4.28-4.02 (m, 2H), 2.50 (s, 3H)

### S.3 6-Trifluoromethoxy-3-[2-fluoro-4-methyl-5-2(2,2,2-trifluoroethylsulfanyl)-phenyl]-3H-quinazolin-4-one

25

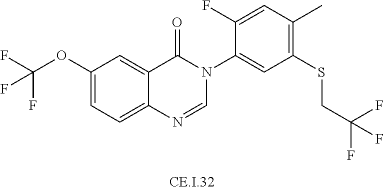 [SMILES: Cc1cc(F)c(-n2cnc3ccc(OC(F)(F)F)cc3c2=O)cc1SCC(F)(F)F]

### 3.1 N-(2-Nitro-5-trifluormethoxy-benzoyl)-3-(2,2,2-trifluoroethylsulfanyl)-4-methyl-6-fluoro-anilide

To a solution of 3-(2,2,2-trifluoroethylsulfanyl)-4-methyl-6-fluoro-aniline (3.0 g, 12.5 mmol) in 75 mL DMF was added 2-nitro-5-trifluoromethoxybenzoic acid (3.15 g, 12.5 mmol), triethylamine (1.5 g, 15 mmol) and HATU (5.7 g, 15 mmol) and the resulting mixture was stirred overnight at room temperature. Water (300 mL) was then added and the reaction mixture was extracted with ethyl acetate (3×100 mL). The organic phase was washed with water (100 mL) and brine (100 mL), dried over magnesium sulfate, filtered and concentrated under reduced pressure. The crude product was purified by column chromatography on silica gel eluting with a gradient of ethyl acetate/cyclohexane to afford the title compound (4.10 g, 69%) as a yellow solid.

### 3.2 N-(2-amino-5-trifluormethoxy-benzoyl)-3-(2,2,2-trifluoroethylsulfanyl)-4-methyl-6-fluoro-anilide

To a suspension of N-(2-nitro-5-trifluormethoxy-benzoyl)-3-(2,2,2-trifluoroethylsulfanyl)-4-methyl-6-fluoro-anilide (4.1 g, 8.7 mmol) in 61 mL ethanol was added Raney nickel (1.0 g) and the stirred mixture was hydrogenated at ambient pressure overnight at room temperature. The solid was filtered off and the filtrate was evaporated to give the intermediate N-(2-amino-5-fluoro-benzoyl)-3-(2,2,2-trifluoroethylsulfanyl)-4-methyl-6-fluoro-anilide (3.0 g, 78%) as a white solid.

### 3.3 6-Trifluoromethoxy-3-[2-fluoro-4-methyl-5-2(2,2,2-trifluoroethylsulfanyl)phenyl]-3H-quinazolin-4-one

A mixture of N-(2-amino-5-trifluoromethoxy-benzoyl)-3-(2,2,2-trifluoroethylsulfanyl)-4-methyl-6-fluoro-anilide (3.0 g, 6.8 mmol), concentrated sulfuric acid (0.15 mL, 2.8 mmol) and 1,1,1-triethoxymethane (15 g) were heated to 140° C. and stirred for 3 hours at this temperature. The mixture was cooled to room temperature, excess of solvent was removed under reduced pressure and the crude product was purified by column chromatography on silica gel eluting with a gradient of ethyl acetate/cyclohexane to afford the title compound I-3 (1.8 g, 59%) as a white solid.

¹H NMR (400 MHz, CDCl₃): δ 8.13 (s, 1H), 8.00 (s, 1H), 7.79 (d, J=9.2 Hz, 1H), 7.65-7.60 (m, 2H), 7.20 (d, J=10.1 Hz, 1H), 3.40 (q, =9.4 Hz, 2H), 2.55 (s, 3H)

### S.4 6-Trifluormethoxy-3-[2-fluoro-4-methyl-5-2(2,2,2-trifluoroethanesulfinyl)-phenyl]-3H-quinazolin-4-one

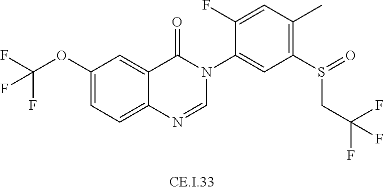 [SMILES: Cc1cc(F)c(-n2cnc3ccc(OC(F)(F)F)cc3c2=O)cc1S(=O)CC(F)(F)F]

To a solution of 6-trifluoromethoxy-3-[2-fluoro-4-methyl-5-2(2,2,2-trifluoroethylsulfanyl)-phenyl]-3H-quinazolin-4-one I-3 (1.5 g, 3.32 mmol) in 128 mL chloroform at 0° C. was added m-chloroperoxybenzoic acid (m-CPBA) (0.74 g, 3.32 mmol, 77% purity) and the reaction mixture was stirred for 3 hours at 0° C. The reaction mixture was then washed with a saturated solution of sodium thiosulfate (100 mL) and a saturated solution of sodium hydrogencarbonate (100 mL). The organic phase was separated, dried over magnesium sulfate, filtered and concentrated under reduced pressure. Recrystallization from hot ethanol afforded the title compound I-4 (0.4 g, 26%) as a white solid.

¹H NMR (400 MHz, DMSO-d6): δ 8.50 (s, 1H), 8.16 (d, J=7.4 Hz, 1H), 8.06 (broad s, 1H), 7.94 (broad s, 2H), 7.61 (d, J=10.7 Hz, 1H), 4.33-4.02 (m, 2H), 2.50 (s, 3H).

### S.5 2-(2,2,2-trifluoroethylsufanyl)-4-(4-oxo-quinazolin-3-yl)-5-fluoro-toluol

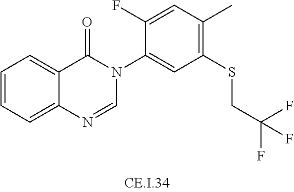 [SMILES: Cc1cc(F)c(-n2cnc3ccccc3c2=O)cc1SCC(F)(F)F]

### 5.1 3-Acetamino-4-fluoro-6-methyl-phenylsulfonylchloride

To a solution of 2-fluoro-4-methyl-aniline (250 g, 2 mol) and triethylamine (202 g, 2 mol) in 2 L of dichloromethane was added dropwise acetylchloride (156 g, 2 mol). The reaction mixture was stirred for 2 hours at a temperature of 0° C. and subsequently washed with dilute hydrochloric acid. The organic phase was dried with sodium sulfate and concentrated under reduced pressure to yield 2-fluoro-4-methyl-acetanilide as a crude intermediate (334 g, 87%).

To 546 g (3.27 mol) of crude 2-fluoro-4-methyl-acetanilide was added chlorosulphonic acid (2000 g, 17.24 mol) with stirring at a temperature below 70° C. Stirring was continued for 3 hours at a temperature of 70° C. The reaction mixture was poured onto ice and then extracted with ethyl acetate. The organic phase was dried with sodium sulfate and concentrated under reduced pressure to yield the title compound (500 g, 57.8%).

¹H NMR (400 MHz, CDCl₃): δ=9.1 (d, 1H, J=7.2 Hz), 7.39-7.52 (m, 1H), 7.14 (d, 1H, J=11.2 Hz), 2.72-2.78 (m, 3H), 2.2-2.3 (m, 3H).

### 5.2 3-(2,2,2-Trifluoroethylsulfanyl)-4-methyl-6-fluoro-aniline

3-Acetamino-4-fluoro-6-methyl-phenylsulfonylchloride (500 g, 1.89 mol) was dissolved in 2 L of acetic acid. Red phosphorus (100 g, 3.22 mmol) and iodine (10 g, 39 mmol) were added to the solution, and the mixture was refluxed for 3 hours. The acetic acid was removed under reduced pressure, water was added and the residue extracted with ethyl acetate. The organic phase was dried with sodium sulfate and concentrated under reduced pressure to give 5-acetamino-4-fluoro-2-methyl-benzenethiol as a crude intermediate (270 g, 72%).

Crude 5-acetamino-4-fluoro-2-methyl-benzenethiol (280 g, 1.41 mol) was added to a 5% (w/w) solution of potassium hydroxide (250 g, 4.46 mol) in water and the mixture was refluxed for 5 hours. The resulting solution was adjusted to pH 7 with dilute hydrochloric acid and was then extracted with ethyl acetate. The organic phase was dried with sodium sulfate and concentrated under reduced pressure to give 5-amino-4-fluoro-2-methyl-benzenethiol as a crude intermediate (160 g, 88%).

¹H NMR (400 MHz, CDCl₃): δ=7.18 (d, 1H, J=1.6 Hz), 6.66-6.74 (m, 2H), 3.2-3.67 (m, 2H), 3.03-3.14 (m, 1H), 2.10-2.15 (m, 3H).

To a solution of potassium hydroxide (78.5 g, 1.4 mol), sodium hydroxymethylsulfinate (Rongalite®, 74.4 g, 0.63 mol) and the crude 5-amino-4-fluoro-2-methyl-benzenethiol (110 g, 0.7 mol) in 380 mL of DMF was added dropwise 2,2,2-trifluoroethyl iodide (147.1 g, 0.704 mol). The reaction mixture was stirred for 2 hours at room temperature, poured into water and then extracted with ethyl acetate. The organic phase was dried with sodium sulfate and concentrated under reduced pressure to yield the title compound (176 g, 99%).

¹H NMR (400 MHz, CDCl₃): δ=6.84-6.89 (m, 1H), 6.7-6.78 (m 1H), 3.4-3.7 (m, 3H), 3.14-3.25 (m, 2H), 2.22-2.26 (m, 3H).

### 5.3 N-(2-Nitro-benzoyl)-3-(2,2,2-trifluoroethylsulfanyl)-4-methyl-6-fluoro-anilide

3-(2,2,2-Trifluoroethylsulfanyl)-4-methyl-6-fluoro-aniline (4.0 g, 16.7 mmol) was dissolved in 100 mL DMF. 2-Nitrobenzoic acid (2.79 g, 16.7 mmol) and triethylamine (2.02 g, 20 mmol) were added to the solution. After cooling to a temperature of 0° C. HATU (7.62 g, 20 mmol) was added in one portion and the resulting mixture was stirred overnight at room temperature. Water was added to the reaction mixture, which was then extracted with ethyl acetate. The organic phase was dried with sodium sulfate and the crude product was purified by column chromatography on silica gel to give the title compound (5 g, 76.9%) as a yellow solid.

¹H NMR (400 MHz, CDCl₃): δ=8.6 (d, 1H, J=7.6 Hz), 8.2 (d, 1H, J=8 Hz), 7.73-7.76 (m, 1H), 7.61-7.67 (m, 3H), 7.0 (s, 1H), 3.39-3.46 (m, 2H), 2.45 (s, 3H).

### 5.4 2-(2,2,2-trifluoroethylsulfanyl)-4-(4-oxo-quinazolin-3-yl)-5-fluoro-toluol

To a suspension of N-(2-nitro-benzoyl)-3-(2,2,2-trifluoroethylsulfanyl)-4-methyl-6-fluoro-anilide (2.3 g, 5.9 mmol) in 230 mL ethanol was added Raney nickel (0.8 g) and the stirred mixture was hydrogenated at ambient pressure overnight at room temperature. The solid was filtered off and the filtrate was evaporated to give the intermediate N-(2-amino-benzoyl)-3-(2,2,2-trifluoroethylsulfanyl)-4-methyl-6-fluoro-anilide (2 g, 95%) as a white solid.

¹H NMR (400 MHz, DMSO-d₆): δ=9.79 (s, 1H), 7.75-7.71 (m, 2H), 7.16-7.24 (m, 2H), 6.72 (d, 1H, J=8.4 Hz), 6.55 (t, 1H, J=7.4 Hz), 6.44 (s, 2H), 3.79-3.87 (m, 2H), 2.38 (s, 3H).

A mixture of the amine N-(2-amino-benzoyl)-3-(2,2,2-trifluoroethylsulfanyl)-4-methyl-6-fluoro-anilide (2.3 g, 6.4 mmol), concentrated sulfuric acid (2 mL) and 1,1,1-triethoxymethane (100 mL) were heated to 140° C. and stirred for 5 hours at this temperature. The mixture was cooled to room temperature, excess of solvent was removed under reduced pressure and the crude product was purified by column chromatography on silica gel to yield the title compound (1.4 g, 59%) as an off-white solid.

Melting point: 145-147° C.

### S.6 2-(2,2,2-trifluoroethylsufinyl)-4-(4-oxo-quinazolin-3-yl)-5-fluoro-toluol

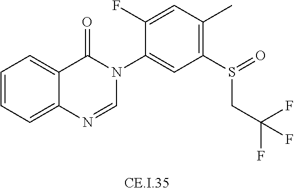 [SMILES: Cc1cc(F)c(-n2cnc3ccccc3c2=O)cc1S(=O)CC(F)(F)F]

2-(2,2,2-Trifluoroethylsulfanyl)-4-(4-oxo-quinazolin-3-yl)-5-fluoro-toluol (0.80 g, 1.96 mmol) was dissolved in 20 mL chloroform and meta-chloroperoxybenzoic acid (0.466 g, 2.29 mmol, 85% of purity) was added under ice-cooling. The reaction mixture was stirred for 1 hour at ice bath temperature. The solution was washed successively with an aqueous solution of sodiumthiosulfate and an aqueous solution of sodiumhydrogencarbonate, and dried with sodium sulfate. After removing excess solvent under reduced pressure the crude product was purified by column chromatography on silica gel to give the title compound (0.32 g, 42.9%) as an off-white solid.

Melting point: 184-186° C.

Biological Tests

The applicability of compounds of formula (I) in application methods according to the present invention may be evaluated in test examples as provided herein below or in similar assays. These test examples are not to be construed in any way as limiting.

B.1 Assays for Spider Mites (Tetranychus)

Test B.1.1 Foliar Assay 2-Spotted Spider Mite (Tetranychus urticae)

The active compounds were formulated in 50:50 (vol:vol) acetone:water and 100 ppm Kinetica™ surfactant.

At about 2 hours before treatment Sieva lima bean plants with primary leaves expanded to 7-12 cm were infested by placing on each a small piece from an infested leaf (with about 100 mites) taken from the main colony in order to allow the mites to move over to the test plant to lay eggs. The piece of leaf used to transfer the mites was removed. The newly-infested plants were dipped in the test solution and allowed to dry. The test plants were kept under fluorescent light (24 hour photoperiod) at about 25° C. and about 20-40% relative humidity. After 5 days mortality counts were made.

In this test, compounds CE.I.6, CE.I.12, CE.I.13, CE.I.14, CE.I.15, CE.I.18, CE.I.19, CE.I.20, CE.I.24, CE.I.28, CE.I.29, CE.I.30, CE.I.31, CE.I.32, CE.I.33, CE.I.34 and CE.I.35 at a concentration of the test solution of 100 ppm showed a mortality of at least 70% in comparison with untreated controls.

Test B.1.2 Foliar Assay Kanzawa Spider Mite (Tetranychus kanzawai)

The active compounds were dissolved at the desired concentration in a mixture of 1:1 (vol:vol) acetone:water. The test solutions were prepared at the day of use. Potted cotton plants colonized with approximately 50 mites of various stages were sprayed after the pest population has been recorded. Population reductions (or increases) after 24, 72 and 120 hours were assessed.

In this test, the compounds CE.I.21, CE.I.24, CE.I.31, CE.I.33, CE.I.34 and CE.I.35 showed a mortality of at least 70% at 100 ppm in comparison with untreated controls.

Test B.1.3 Soil Drench Assay in Lima Bean

Test solution comprising a compound of the present invention was prepared at desired concentration using water and an organic solvent. Potted lima been plants were treated with test solution by means of soil drenching. The test compounds were applied as a soil drench in 2 ml of solution at the rate of 4 mg active ingredient/plant (2 mg/ml). Technical material was dissolved in acetone, and distilled water was added to achieve a final concentration of 5% acetone. Four days after treatment, a mixed population of two spotted spider mites (Tetranychus urticae) was released onto the leaves. After infestation, plants were kept on a light cart in the laboratory and top watered daily.

Five days after the release of spider mites, the acaricidal efficacy is measured by means of the rating of the damage caused by spider mites or the spider mite mortality: the number of TSSM were counted on plants, percent damage as lesions was visually assessed and means were calculated for each treatment. Mean percent population reduction relative to the solvent blank control was calculated. Mean percent reduction in damage relative to the solvent blank was calculated as 100-(Mean % lesions in treatment/Mean % lesions in Solvent blank)*100.

In this test, the compound CE.I.35, showed a mortality of at least 90% at 4 mg active ingredient/plant in comparison with untreated controls. The compound CE.I.35 showed a mean percent damage reduction of at least 70% at 4 mg active ingredient/plant in comparison with untreated controls.

Test B.1.4 Seed Treatment Assay in Cotton

Test solution comprising a compound of the present invention is prepared at desired concentration using water and an organic solvent. Cotton seeds are coated with such prepared test solution at the rate 0.5 mg active ingredient/seed and sown to the pots. After plant emergence, a mixed population of two spotted spider mites is released onto the leaves.

Four days after the release of spider mites, the acaricidal efficacy is measured by means of the rating of the damage caused by spider mites or the spider mite mortality: percent damage as lesions was visually assessed and means were calculated for each treatment. Mean percent reduction in damage relative to the solvent blank was calculated as 100−(Mean % lesions in treatment/Mean % lesions in Solvent blank)*100.

In this test, the compound CE.I.35, showed a mean percent damage reduction in the cotyledon stage of at least 90% at 0.5 mg active ingredient/seed in comparison with untreated controls. Plant emergence was 96-100% and no phytotoxicity was observed.

Test B.1.5 Seed Treatment Assay in Cucumber

Test solution comprising a compound of the present invention is prepared at desired concentration using water and acetone as organic solvent. Cucumber seeds are coated with such prepared test solution applied at the rate of 0.5 mg active ingredient/seed and sown to the pots. After plant emergence (eleven days after treatment & planting), a mixed population of two spotted spider mites is released onto the leaves.

Four days after the release of spider mites, the acaricidal efficacy is measured by means of the rating of the damage caused by spider mites.

Percent damage as lesions was visually assessed, and means were calculated for each treatment. Mean percent damage reduction relative to the solvent blank was calculated as 100−(mean % lesions in treatment/mean % lesions in Solvent blank)*100.

In this test, the compound CE.I.35, showed a mean percent damage reduction in the cotyledon stage of at least 50% at 0.5 mg active ingredient/seed in comparison with untreated controls.

B.2 Assays for Nematode (Melodogyne)

Test B.2.1 Tomato Soil Drench Against Root-Knot Nematode Juveniles

Tomatoes were grown in potting soil until the approximate first true leaf stage (about 2 weeks after planting). Tomatoes were transplanted into play sand. Seven days after transplant, technical material of test compound was dissolved in acetone, and then water was added to achieve a final concentration of 50% acetone. 1 mL of solution was pipetted onto the tomato root zone. One day after treatment (DAT), each pot was infested with about 500 root-knot nematode (Meliodogyne spp.) juveniles in 1 ml distilled water. Immediately after infestation, plants were placed in the greenhouse. Plants were top watered and fertilized daily. At 14 DAT, the tomato roots were rinsed off, and the number of galls was counted. Replication was 5-times.

In this test, the compound CE.I.31 showed a mean percent reduction of galls of at least 90% at 0.75 mg active ingredient/plant in comparison with untreated controls.

1-35. (canceled)

36. A method for controlling and/or combating animal pests in soil comprising applying a pesticidally effective amount of a compound of formula (I): 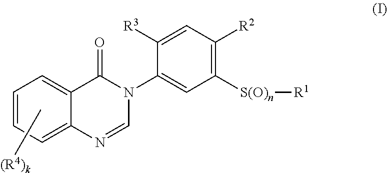
wherein
R¹ is C₁-C₄-alkyl, fluorinated C₁-C₄-alkyl, C₂-C₄-alkenyl, fluorinated C₂-C₄-alkenyl, cyclopropyl or cyclopropylmethyl;
R² is hydrogen, halogen, CN, C₁-C₄-alkyl or C₁-C₄-haloalkyl;
R³ is hydrogen, halogen, CN, C₁-C₄-alkyl or C₁-C₄-haloalkyl;
R⁴ is selected independently from the integer of k from the group consisting of halogen, CN, NO₂, C₁-C₄-alkyl, C₁-C₄-haloalkyl, C₂-C₄-alkenyl, C₁-C₄-haloalkenyl, C₂-C₄-alkynyl, C₁-C₄-haloalkynyl, C₁-C₄-alkoxy-C₁-C₄-alkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl and C₁-C₄-haloalkylsulfonyl;
k is 0, 1, 2, 3 or 4;
n is 0, 1 or 2;
or a tautomer, enantiomer, diastereomer or salt thereof, to a plant and/or to plant propagation material by drenching the soil, by drip application onto the soil, by soil injection, by dipping or by treatment of seeds.

37. The method of claim 36, wherein in the active compound I of formula (I) R¹ is 2,2,2-trifluoroethyl.

38. The method of claim 36, wherein in the active compound of formula (I) R³ is selected from hydrogen, fluorine, chlorine, methyl or trifluoromethyl; and R² is selected from chlorine, methyl, difluoromethyl, trifluoromethyl or cyano.

39. The method of claim 36, wherein in the active compound of formula (I) R³ is fluorine; and R² is methyl.

40. The method of claim 36, wherein in the active compound of formula (I) k is 0.

41. The method of claim 36, wherein in the active compound of formula (I) k is 1, 2 or 3 and R⁴ is selected independently from the integer of k from the group consisting of fluorine, chlorine, cyano, methyl, trifluoromethyl, methoxy, difluoromethoxy and trifluoromethoxy.

42. The method of claim 36 wherein said compound has formula (I-A) 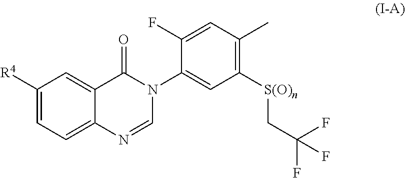
wherein in compound of formula (I-A)
n is 0 or 1; and R⁴ is selected from fluorine, chlorine, cyano, methyl, trifluoromethyl, methoxy, difluoromethoxy or trifluoromethoxy.

43. The method of claim 36 wherein said compound has formula (I-B) 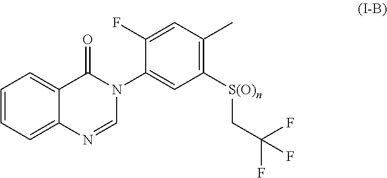
wherein in compound of formula (I-B) n is 0 or 1.

44. The of claim 36, wherein the plant or the plant propagation material to be treated is grown in an artificial growth substrate.

45. The method of claim 44, wherein the artificial growth substrate is selected from the group consisting of rock wool, glass wool, quart sand, gravel, expanded clay and vermiculite.

46. The method of claim 36, wherein the plant or plant propagation material to be treated is planted or growing in a closed system.

47. The method of claim 36, wherein the plant or the plant propagation material to be treated is selected from the group consisting of vegetables, spices, herbs, ornamentals, conifers, shrubs, cotton, tropical crops, citrus plants, fruits, nuts and grape vines.

48. The method of claim 36, wherein the plant propagation material to be treated are seeds.

49. The method of claim 36, wherein the active compound of formula (I) is applied by drenching the soil.

50. The method of claim 36, wherein the active compound of formula (I) is applied by drip irrigation.

51. The method of claim 36, wherein the active compound of formula (I) is applied with drip application systems.

52. The method of claim 36, wherein the active compound of formula (I) is applied by soil injection.

53. A method for protecting plants from attack or infestation by insects, arachnids or nematodes comprising contacting the soil or the artificial growth substrate in which the plant is growing, with a compound of formula (I) 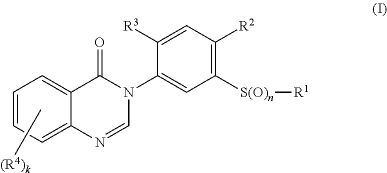
wherein
R¹ is C₁-C₄-alkyl, fluorinated C₁-C₄-alkyl, C₂-C₄-alkenyl, fluorinated C₂-C₄-alkenyl, cyclopropyl or cyclopropylmethyl;
R² is hydrogen, halogen, CN, C₁-C₄-alkyl or C₁-C₄-haloalkyl;
R³ is hydrogen, halogen, CN, C₁-C₄-alkyl or C₁-C₄-haloalkyl;
R⁴ is selected independently from the integer of k from the group consisting of halogen, CN, NO₂, C₁-C₄-alkyl, C₁-C₄-haloalkyl, C₂-C₄-alkenyl, C₁-C₄-haloalkenyl, C₂-C₄-alkynyl, C₁-C₄-haloalkynyl, C₁-C₄-alkoxy-C₁-C₄-alkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl and C₁-C₄-haloalkylsulfonyl;
k is 0, 1, 2, 3 or 4;
n is 0, 1 or 2;
or a tautomer, enantiomer, diastereomer or salt thereof in a pesticidally effective amount.

54. A method for controlling or combating insects, arachnids or nematodes comprising contacting the soil or the artificial growth substrate in which the plant is growing, with of formula (I) 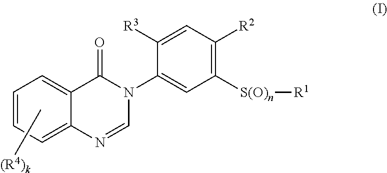
wherein
R¹ is C₁-C₄-alkyl, fluorinated C₁-C₄-alkyl, C₂-C₄-alkenyl, fluorinated C₂-C₄-alkenyl, cyclopropyl or cyclopropylmethyl;
R² is hydrogen, halogen, CN, C₁-C₄-alkyl or C₁-C₄-haloalkyl;
R³ is hydrogen, halogen, CN, C₁-C₄-alkyl or C₁-C₄-haloalkyl;
R⁴ is selected independently from the integer of k from the group consisting of halogen, CN, NO₂, C₁-C₄-alkyl, C₁-C₄-haloalkyl, C₂-C₄-alkenyl, C₁-C₄-haloalkenyl, C₂-C₄-alkynyl, C₁-C₄-haloalkynyl, C₁-C₄-alkoxy-C₁-C₄-alkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl and C₁-C₄-haloalkylsulfonyl;
k is 0, 1, 2, 3 or 4;
n is 0, 1 or 2;
or a tautomer, enantiomer, diastereomer or salt thereof in a pesticidally effective amount.

55. The method of claim 53, wherein the compound is applied in an amount of from 5 g/ha to 2000 g/ha.

56. The method of claim 54, wherein the compound is applied in an amount of from 5 g/ha to 2000 g/ha.

57. A method for protection of plant propagation material comprising contacting the plant propagation material with a compound of formula (I) of formula (I) 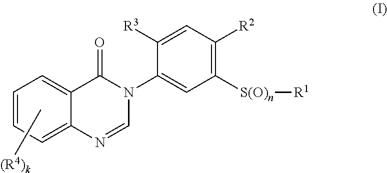
wherein
R¹ is C₁-C₄-alkyl, fluorinated C₁-C₄-alkyl, C₂-C₄-alkenyl, fluorinated C₂-C₄-alkenyl, cyclopropyl or cyclopropylmethyl;
R² is hydrogen, halogen, CN, C₁-C₄-alkyl or C₁-C₄-haloalkyl;
R³ is hydrogen, halogen, CN, C₁-C₄-alkyl or C₁-C₄-haloalkyl;
R⁴ is selected independently from the integer of k from the group consisting of halogen, CN, NO₂, C₁-C₄-alkyl, C₁-C₄-haloalkyl, C₂-C₄-alkenyl, C₁-C₄-haloalkenyl, C₂-C₄-alkynyl, C₁-C₄-haloalkynyl, C₁-C₄-alkoxy-C₁-C₄-alkyl, C₁-C₄-alkoxy, C₁-C₄-haloalkoxy, C₁-C₄-alkylthio, C₁-C₄-haloalkylthio, C₁-C₄-alkylsulfinyl, C₁-C₄-haloalkylsulfinyl, C₁-C₄-alkylsulfonyl and C₁-C₄-haloalkylsulfonyl;
k is 0, 1, 2, 3 or 4;
n is 0, 1 or 2;
or a tautomer, enantiomer, diastereomer or salt thereof in a pesticidally effective amount.

58. The method of claim 57, wherein the compound is applied in an amount of from 0.1 g to 10 kg per 100 kg of plant propagation material.

59. The method of claim 57, wherein the plant propagation material are seeds.

60. The method of claim 59, wherein the seeds are of a transgenic plant.

61. The method of claim 57, wherein the plant roots and shoots resulting from the treated seeds are protected.

62. The method of claim 53, wherein the active compound is applied by drenching the soil.

63. The method of claim 53, wherein the active compound is applied by drip irrigation.

64. The method of claim 53, wherein the active compound is applied by soil injection.

65. The method of claim 53, wherein the active compound is applied by dipping roots, tubers or bulbs.

66. The method of claim 53, wherein the active compound is applied with drip application systems.

67. The method of claim 53, wherein the plants, the plant propagation material or the plant roots and shoots resulting from the treated plant propagation material are protected from the attack by soil pests or foliar pests.

68. The method of claim 53, wherein the plants, the plant propagation material or the plant roots and shoots resulting from the treated plant propagation material are protected from the attack by insects, arachnids and/or nematodes.

69. The method of claim 53, wherein the plants, the plant propagation material or the plant roots and shoots resulting from the treated plant propagation material are protected from the attack by acaridae.

70. The method of claim 53, wherein the animal pests to be controlled or to be combated are arachnids, insects or nematodes.

71. The pesticidal active 3-arylquinazolin-4-one compound of claim 36, wherein the animal pests to be controlled or to be combated are arachnids, insects or nematodes.

72. A seed treated the compound of claim 36 in an amount of from 0.1 g to 10 kg per 100 kg of seeds.
